(19) United States
(12) Patent Application Publication
(10) Pub. No.: US 2009/0192869 A1
(43) Pub. Date: Jul. 30, 2009

(54) Marketing Control Center

(76) Inventors: Steven R. Irvine, Toronto (CA); Shane Sincich, Toronto (CA); Roland Lopes, Toronto (CA); Andrew Muroff, Toronto (CA)

Correspondence Address: Gowling Lafleur Henderson LLP, Suite 1600 - 1 First Candian Place, 100 King St. West, Toronto, ON, M5X 1G5, CA

(21) Appl. No.: 12/020,201

(22) Filed: Jan. 25, 2008

(51) Int. Cl. G06Q 10/00

(52) U.S. Cl. 705/10; 705/14

(57) ABSTRACT

A computer system is configured to implement efficient marketing campaigns across a plurality of platforms to a plurality of consumers. The computer comprising memory and a processor for storing an executing instructions for implementing the marketing campaign. The memory includes a community manager, campaign manager, content management system and rules engine. The community manager is configured to allow a user to manage and dynamically segment the plurality consumers. The campaign manager is configured to allow the user to establish a plurality of marketing campaigns for targeting at least a predefined segment of the plurality of consumers, each of the marketing campaigns including a plurality of different tactics. The content management system is configured to allow the user to create, host and manage content in real-time for the marketing campaign. The rules engine is configured to implement one or both of different tactics or different campaigns in accordance a predefined set of rules, each rule defining a trigger event and corresponding rule criteria. The processor is further configured to implement the rules when the trigger event is detected and the rules criteria are met, thereby facilitating cross-platform integration.

The present invention relates generally to a system and method for providing marketers with a tool to improve efficiency and effectiveness in reaching a target audience.

### BACKGROUND

Marketing is an essential aspect of any successful business. Through effective marketing, businesses can develop product policy, determine pricing, produce effective advertising and communications, perform better marketing research, and understand channels of distribution. Marketing also allows businesses to understand customer behaviour, competitive marketing activities, and organizational considerations.

Even though marketing is an essential component of any business, it is often difficult to implement marketing effectively. Accordingly Customer Relationship Management (CRM) tools have been developed to assist marketers improve performance.

However, although traditional CRM tools are great at tracking leads, quotes/proposals, and sales cycle activity, they fall short when it comes to focusing on the ‘marketing processes’ that lead to customer acquisition.

Moreover, advertising and marketing strategies such as online (Web-based) advertising and mobile advertising have grown dramatically over the past view years. Traditional CRM tools often fall short of Accordingly, there is a need for a marketing tool that assists marketers implementing a marketing process to target customers efficiently and effectively.

### SUMMARY

In order to address the shortcomings of the prior art, a marketing control center (MCC) is proposed. The MCC picks up where currently available CRM tools have fallen short by providing effective marketing automation that targets the right customer, with the right offer, at the right time.

Until now, interactive marketers have had to rely on multiple specialized vendors to supply all of the functions they required in order to manage campaigns that incorporate traditional, interactive and emerging media and tactics. This required administration of multiple outsourced partners (one for email, one for surveys, one for website creation, etc.) and the manual consolidation of multiple reports or tracking outputs. As a result, there was a significant layer of administrative time and effort that delayed review of results and ultimately increased the cost and barriers to running effective online and mobile campaigns for end clients.

Online campaigns are marketing campaigns delivered through the Internet. Examples of such campaigns include electronic newsletters (e-newsletters), online contests, web logs (blogs), online surveys, electronic coupons (e-coupons) and the like. Mobile campaigns are marketing campaigns delivered through a mobile communication device such as a cellular phone, smart phone or portable digital assistant (PDA). Examples of the such campaigns include mobile newsletters (m-newsletter), mobile contests, text voting (eg. American Idol), mobile trivia, mobile coupons (m-coupons) and the like.

Accordingly, one vendor would provide online surveys, while another would fulfill mass email deployments, while yet another might manage a regular monthly e-newsletter or mobile text message delivery. Finally, to track and report on the results of these functions, it would be required to export the results of each into an Excel spreadsheet, manually sort and parse the data and then manually generate the graphs to display the results. The combination of these factors prohibits clients from receiving important real-time visibility into campaign performance and hence restricts their ability to effectively manage campaign tactics mid-stream.

The MCC technically integrates and effectively consolidates control and execution of all of these marketing tactics into one interface and provides real-time and comprehensive tracking and reporting across the entire suite and lifecycle of the campaigns.

In accordance with an aspect of the present invention there is provided a method for providing efficient marketing campaigns across a plurality of platforms to a community or a plurality of consumers, the community comprising a plurality of segments defined by applying predefined filters to the community; the method comprising the steps of: deploying marketing campaigns that target one or more segment of the community; detecting triggers based on events, the events based on predefined event criteria; and implementing cross-platform integration by deploying further marketing campaigns in accordance with a predefined rule set, the rule set configured to deploy the further marketing campaigns in accordance with the detected trigger and predefined rules criteria.

In accordance with a further aspect of the present invention, there is provided a computer system configured to implement efficient marketing campaigns across a plurality of platforms to a plurality of consumers, the computer comprising memory for storing: a community manager configured to allow a user to manage and dynamically segment the plurality consumers; a campaign manager configured to allow the user to establish a plurality of marketing campaigns for targeting at least a predefined segment of the plurality of consumers, each of the marketing campaigns including a plurality of different tactics; a content management system configured to allow the user to create, host and manage content in real-time for the marketing campaign; and a rules engine configured to implement one or both of different tactics or different campaigns in accordance a predefined set of rules, each rule defining a trigger event and corresponding rule criteria; the computer further including a processor configured to execute the community manager, the campaign manager and the content manager, as well as to implement the rules when the trigger event is detected and the rules criteria are met, thereby facilitating cross-platform integration.

In accordance with yet a further aspect of the present invention, there is provided a client computer configured to access a server via a network, the server implementing efficient marketing campaigns across a plurality of platforms to a plurality of consumers the server comprising memory for storing: a community manager configured to allow a user to manage and dynamically segment the plurality consumers; a campaign manager configured to allow the user to establish a plurality of marketing campaigns for targeting at least a predefined segment of the plurality of consumers, each of the marketing campaigns including a plurality of different tactics; a content management system configured to allow the user to create, host and manage content in real-time for the marketing campaign; and a rules engine configured to implement one or both of different tactics or different campaigns in accordance a predefined set of rules, each rule defining a trigger event and corresponding rule criteria; the server further including a processor configured to execute the community manager, the campaign manager and the content manager, as well as to implement the rules when the trigger event is detected and the rules criteria are met, thereby facilitating cross-platform integration; the client computer configured to allow the user to access the server in order to create and manage marketing campaigns and to view information executing by the server on a screen local to the client computer.

### BRIEF DESCRIPTION OF THE DRAWINGS

An embodiment of the present invention will now be described by way of example only with reference to the following drawings in which:

FIG. 1 is a block diagram of a network infrastructure used to implement the invention;

FIG. 2 is a block diagram of the architecture of the marketing control center (MCC);

FIG. 3, is a screenshot of a login page of the MCC;

FIG. 4 is a screenshot of a main page of the MCC;

FIGS. 5e-f are screenshots of a campaign manager of the MCC;

FIGS. 6a-d are screenshots of a community manager of the MCC;

FIGS. 7a-d are screenshots of a segment manager of the MCC;

FIGS. 8a-d are screenshots of a CMS of the MCC;

FIGS. 9a-f are screenshots of a contest manager of the MCC;

FIGS. 10a-f are screenshots of an email deployment section of the MCC;

FIG. 11 is a screenshot of a SMS deployment section of the MCC;

FIGS. 12a-d and 13 are screenshots of an analytics section of the MCC;

### DETAILED DESCRIPTION OF THE PREFERRED EMBODIMENT

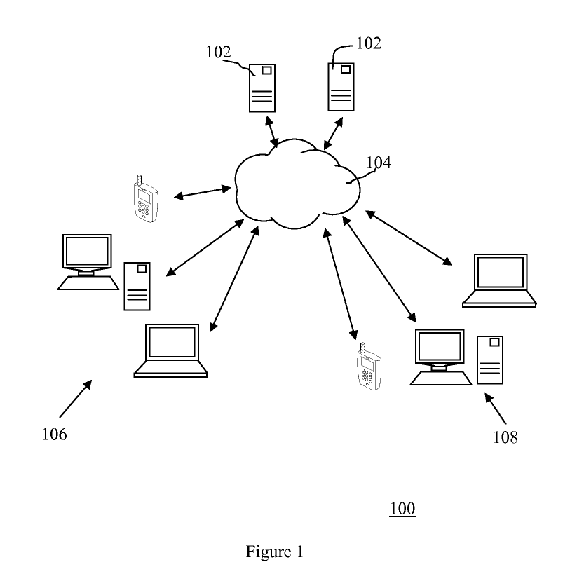

For convenience, like numerals in the description refer to like structures in the drawings. Referring to FIG. 1, a network infrastructure on which the marketing control center (MCC) is implemented is illustrated generally by numeral 100. The network infrastructure includes a plurality of servers 102, a communication network 104, a plurality of potential consumer devices 106 and marketer devices 108.

The servers 102 supply content to the devices 106 and 108. Specifically, the servers 102 are capable of hosting applications, Web sites, and providing access data-sources 108, such as Web services, database services, as well as other enterprise services.

For the purpose of the present description, a marketer device 108 is a device that is used by marketing personnel to establish a marketing strategy. In the present embodiment the device is a computing device configured to access the MCC. Consumer devices 106 are devices that individuals use to access the communication network (104)

Accordingly, the marketer devices 106 and the client devices 108 may include both wired and wireless computing devices such as a desktop computer, a notebook or other portable computer, a smart phone, a personal digital assistant (PDA), and the like. The marketer devices 106 and the client devices 108 are capable of communicating with the servers 102 via the communication network 104.

Therefore, the communication network 104 may include several components such as a wireless network, a relay, a corporate server and/or a mobile data server for relaying data between the devices 106 and 108 and the servers 102. Furthermore, the communication network 104 may include a wide area network (WAN) and/or a local area network (LAN). This includes, for example, public networks such as the Public Switched Telephone Network (PSTN) and the Internet, as well as private networks. The actual configuration of the communication network 104 may vary, depending on the network provider as well as the type of devices 106 and 108, as will be appreciated by a person of ordinary skill in the art.

In the present embodiments, the MCC is implemented on one of the servers 102 using an application service provider (ASP) or Software as a Service (SaaS) model. ASPs are well known in the art and need not be described in detail. Effectively, an ASP allows a customer to “lease” an application. In exchange for a “per-use” or a monthly/annual fee, the ASP provides the customer with access to software that is owned, updated and supported by the ASP. It will be appreciated by a person of ordinary skill in the art that the MCC may be located on a single server or distributed amongst a plurality of servers connected via the communication network 104.

As will be described below, the MCC is configured to enable marketers that have little technical expertise to create interactive web portals, deploy and manage integrated online/mobile marketing campaigns, build permission-based communities, and gain real-time visibility across a variety of marketing activities in order to efficiently manage resources and maximize return on investment. It should be noted that the term “user” is used herein to refer generically to a person using the MCC, such as a marketer for example, regardless of their actual job-description or level of technical expertise.

In order to achieve this goal, tasks previously administered offline by marketing coordinators have been streamlined and automated in the MCC so that the resources can be used more effectively. Furthermore, bringing all of these features together allows further improvements to be implemented. For example, cross-platform integration can be achieved by implementing a rule-engine. As will be described, users can establish rules that facilitate multi-platform marketing strategies that were not previously possible. Furthermore, because real-time feedback is provided, the users are able to change their strategies dynamically during a campaign. Yet further, because the MCC can provide detailed information regarding the marketing tactics at a granular level, a concept of brand engagement can be applied. That is consumers targeted by a marketing campaign can be assigned point based on their activities. The point can be weighted depending on the activity. For example, person A may be more inclined to sign up new parties than person B, even though both person A and person B respond equally to the tactics. Accordingly, brand engagement can be used to recognize a consumer's involvement with a brand and, combined with the rules, can provide a unique opportunity to maximize their potential as consumers.

All of these factors allow the users to pay more attention to managing the campaign strategy and monitoring performance via real-time analytics. The MCC helps users improve response rates and return on investment from marketing efforts by affording the ability to easily manage sophisticated, timely, personalized customer communication, promotional, and loyalty strategies.

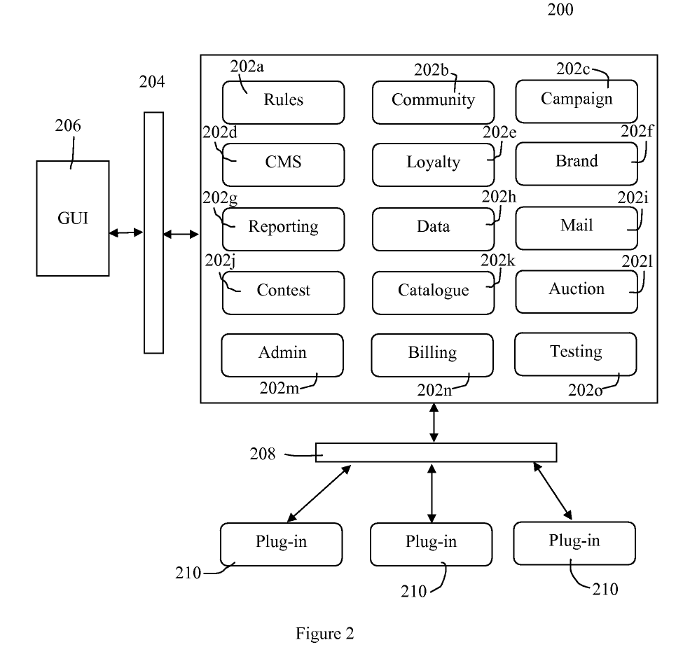

Referring to FIG. 2, the architecture of the MCC is illustrated generally by numeral 200. The MCC is a collection of modules 202 that work together to provide the required functionality. For example, the present embodiment of the MCC 200 includes a rules engine 202a, a community manager 202b, a campaign manager 202c, a content management system (CMS) 202d, a loyalty module 202e, a brand engagement module 202f, a reporting module 202g, a data import module 202h, a mailing module 202i, a contest module 202j, a catalogue module 202k, an auction module 202l, and administration module 202m, a billing module 202n, and a testing module 202o.

The MCC 200 includes a client interface Application Program Interface (API) 204 for allowing third parties to develop their own user interfaces to the MCC 200. In the present embodiment, a default user interface 206 is provided so that access to the MCC 200 is readily available. The default user interface is customizable and can be “white-labeled” so that it can be tailored for a specific marketer's brand or vertical or market segment.

As will be appreciated, additional modules, referred to as enhancement modules 210, can be added to enhance the functionality of the MCC 200. Accordingly, the MCC 200 further includes an integration API 208, which allows for integration of internal or externally developed enhancement modules 210 without requiring that they be hard coded into the MCC 200. This provides the opportunity for third parties to develop an enhancement module 210. Therefore, if a user has a niche area to add to the MCC 200, it could be achieved by adding the module via the integration API and providing access to the added module via custom screens on the user interface. However, it will be apparent that such enhancement modules may be integrated in the MCC 200, if it is so desired.

At present, examples of additional modules that will be implemented as part of the MCC 200 or as enhancement modules 210 include functionality for third-party tactics and campaigns such as e-mail, coupon, contest, survey, ad serving, search tools, social networking, auctions, e-commerce, short message service (SMS), multimedia message service (MMS), direct mail, call centre, interactive voice response (IVR), media planning, lists, CRM, project management, fulfillment; analytics, maps, digital signage, gaming, television (including direct response TV), events, invoicing and the like.

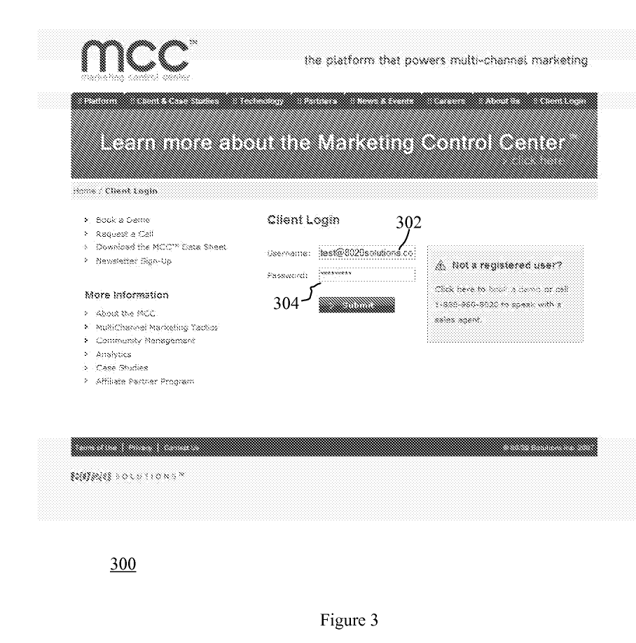

Referring to FIG. 3, a sample login screen is illustrated generally by numeral 300. As is standard in the art, the login screen 300 includes a user name text entry box 302 and a password text entry box 304 for providing secure access for each user to their respective information.

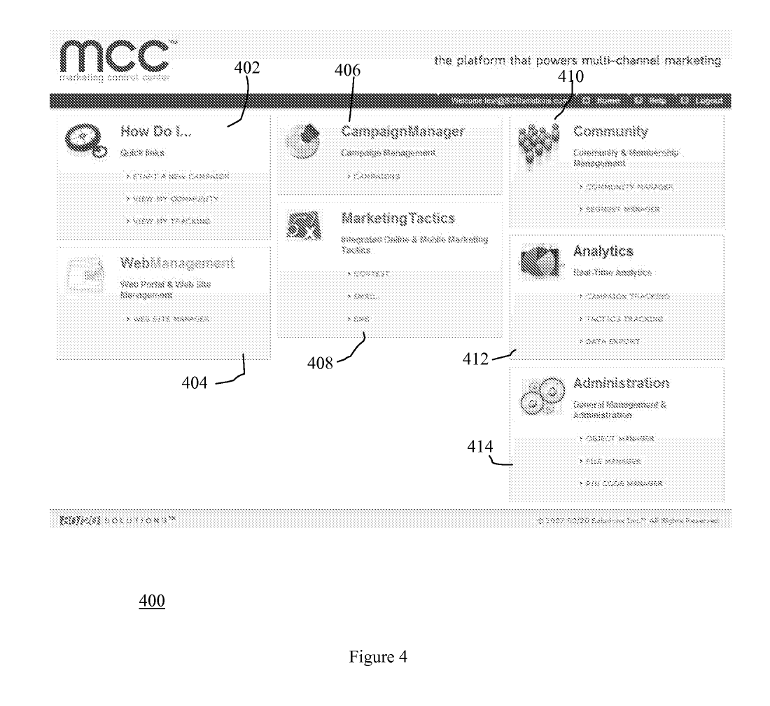

Referring to FIG. 4, a sample main screen is illustrated generally by numeral 400. As shown, the main screen 400 includes seven sections: help 402; web management 404; campaign management 406; marketing tactics 408; community 410; analytics 412; and administration 414.

The help section 402 provides users with assistance for using the MCC 200. For example, the help section 402 can provide a Frequently Asked Questions (FAQ) and/or step-by-step instructions to assist the user with more common tasks. Helps sections are well known in the art and need not be described in great detail.

The web management section 404 provides access to the CMS module 202d for enabling the user to manage web portals and web sites for the marketing campaigns. The CMS module 202d provides tools for creating, managing, and updating web properties using a simple point-and-click interface. Such tools are well known in the art and have been customized to provide the necessary functionality for the MCC 200.

More specifically, the website manager allows users of the MCC to setup new domain names, create new web sites, select supported languages, and link directly to the web portal for management of web site content. Accordingly, it will be appreciated that the website manager provides several advantages. For example, administrators are provided with a central location for web site administration of one or more marketing campaigns. Built-in logic is provided for managing multi-lingual web sites. The application can be managed by non-technical staff. Integration with the web portal provides web content editing. Accordingly it will be appreciated that all of the advantages expedites the setup of web sites for a marketing campaign.

The web portal is a comprehensive and robust content management system that enables non-technical users to manage web content. The web portal integrates with the marketing tactics available in the MCC 200, such as contests, surveys, coupons, loyalty programs and the like.

The campaign management section 406 provides users with a list of existing marketing campaigns as well as the ability to quickly and easily create new marketing campaigns or editing existing marketing campaigns, which may be running simultaneously. Advertising Agencies and enterprise marketing departments will appreciate the time and cost savings realized by having a central campaign management tool from which to organize and control all marketing campaigns.

The campaign management section 406 provides access to the campaign management module 202c, which is an intuitive tool for managing interactive marketing campaigns deployed through the MCC 200. It provides flexibility by allowing the user to setup overall campaign properties and goals prior to choosing which marketing tactics to employ.

The marketing tactics section 408 provides a fully integrated multi-channel suite of marketing tactics, thereby providing users with the ability to provide interactive marketing. Until now, marketers would have to use separate vendors or software platforms to execute each individual tactic within their marketing campaign, resulting in obvious management, resource, cost, and tracking problems. The MCC 200 overcomes these problems by allowing marketers to create innovative multi-channel campaigns on the fly from one user interface 206, involving a number of different integrated and interactive tactics. Some examples of different tactics made available via the MCC 200 include the following.

Contests provide one way to build a database of consumers and capture permissions for future communications. Contests are a highly popular and proven online customer acquisition vehicle which often delivers a return on investment better than traditional marketing channels.

Surveys provide one way to build a database of preferences, specific to individual contacts. Surveys are a natural and logical extension to online contests. Surveys provide an outlet for consumers to share their opinions on topics such as new product development, marketing tactics, and brand perception.

Instant win promotions provide instant gratification to consumers and deliver the immediate and strategic customer interaction. Instant win promotions can create urgency and drive viral marketing among consumers.

Intelligence for the contests, surveys and instant win promotions is provided by the contest module 202j.

The mail module 202i allows users to provide both electronic mail (e-mail) and mobile communications (m-mail/SMS/MMS) options to their community members, while seamlessly tracking the results in real-time from one central location. Users can measure the effectiveness and performance of each method of communication and deliver content to their communities in the manner by which they are most responsive.

Additionally, the mail module 202i allows marketers to manage electronic and mobile newsletter deployments from one user interface. For example, companies can use the MCC 200 to keep track of which community members wish to receive an online version, which members want to receive a mobile version, and which ones like to receive both. Built-in tracking and analytics will show which one of these groups is most receptive to which offers and the consistent communication will ensure that the community is regularly engaged.

Coupons can be provided by a coupon module (currently not part of the MCC 200). The coupon module provides customizable coupon promotions or tactics that can be integrated with offline coupon redemption. The coupon module can produce serialized coupons, alert consumers, and offer real-time tracking. The MCC can track the effectiveness of the coupon promotions versus other promotions.

The loyalty module 202e allows companies to run and manage points-based loyalty programs. Administration of point values, transaction processing/assignment of rewards to individuals, and fulfillment of prizing elements can all be automatically managed through the MCC 200. Participants can register online and access their point balance in real-time. Points can be redeemed in a variety of ways including auctions, contests, shopping, downloads, and coupons, which opens the door to multi-channel programs aimed at retaining and rewarding the best customers.

The community section 410 of the main screen 400 allows users to effectively manage their communities and external lists in one central location. The data import module 202h allows users to upload existing community lists for easy synchronization with other enterprise platforms. Alternatively, users can build communities organically through marketing tactics such as contests and surveys. Further comprehensive and customizable tools are provided to segment communities, such as demographic or geographic filters for example.

The analytics section 412 provides access to the reporting module 202g, which provides real-time access to campaign tracking and reporting across the marketing activities in order to monitor campaign success. With this analysis, users can modify campaigns and shift resources dynamically in order to maximize marketing ROI.

Specifically, campaign tracking provides users with accurate and actionable program results on-demand. This, in turn, provides the data and confidence necessary to make decisions quickly and decisively. With visibility into marketing spending, companies have the ability to more accurately track return on marketing investment (ROMI) and mitigate campaign risk.

Reporting provides detailed reports on the marketing campaign activities and community engagement. In contrast to the campaign tracking, which is usually graphical, on-demand reporting provides granular, raw reporting that can be customized based on user-specified variables, such as time and region for example.

The administration section 414 is an interface to a suite of management tools provided by the administration module 202m. These tools facilitate simple management of the features in the MCC 200 effectively. The administration module 202m also allows the an administrator to manage all aspects of the MCC 200, including setting up new users, defining user permissions, and changing company information. The following provides examples of several of the management tools.

An object manager allows users to setup items, such as company products, that will be used repeatedly in marketing campaigns as “objects”. These objects can be inserted directly into various marketing tactics and used as prizes in contest, rewards items in loyalty programs, coupons in coupon programs and the like.

A file manager provides a central repository for documents, images, and media used in the MCC 200. Files can be uploaded in bulk or individually and will reside in the file manager. Access to the files can be made restricted, if so desired. The administration module 202m is integrated with the other modules in such a way as to ensure content updating is simple and effective.

A personal identification number (PIN) code manager provides the ability to dynamically create and manage PIN code lists. Commonly used in large-scale contests and loyalty programs, PIN codes can be printed or distributed virtually to track and reward purchase behaviour. The PIN code manager allows users to upload existing PIN lists via the data import module 202h, or create new dynamic lists of PIN codes.

A short codes manager is also provided. Short codes are shorter phone numbers, typically 4-6 digits, which are specifically licensed by regional wireless associations and mobile carriers for SMS campaigns. The short code manager simplifies and automates the process of completing the short code registration form. That registration form is then submitted to the respective national wireless association for approval. Once approved, the short code will be active for use in the mobile marketing tactics.

From the above-description, it will be appreciated that the MCC 200 features a business-logic layer that is familiar to users in terms of functionality, terminology, and purpose. As will be described below, it is comprehensive in terms of features, yet the complexity is hidden behind a wizard-style step-by-step interface. Underneath the interface is a back-end platform that is both robust and secure. The result is an easy-to-use, reliable, and secure tool for creating and managing interactive campaigns that requires little or no technical background to administer.

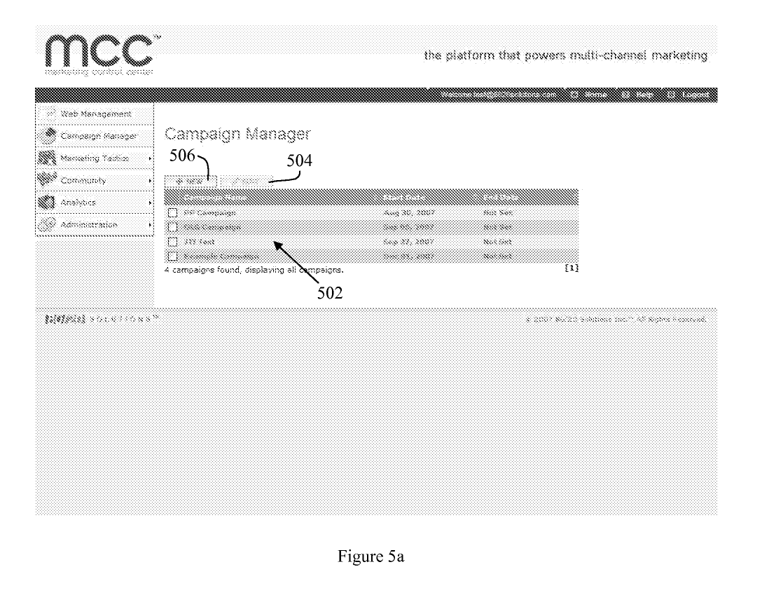

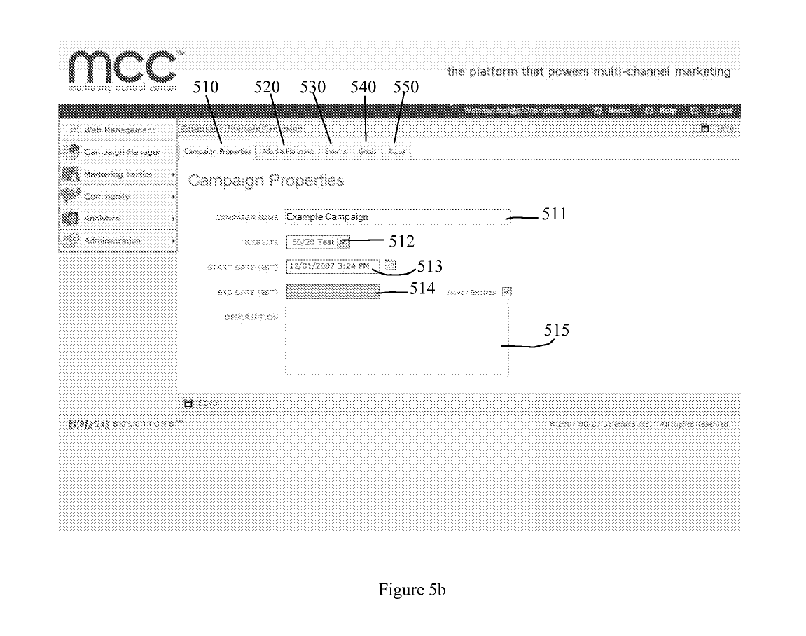

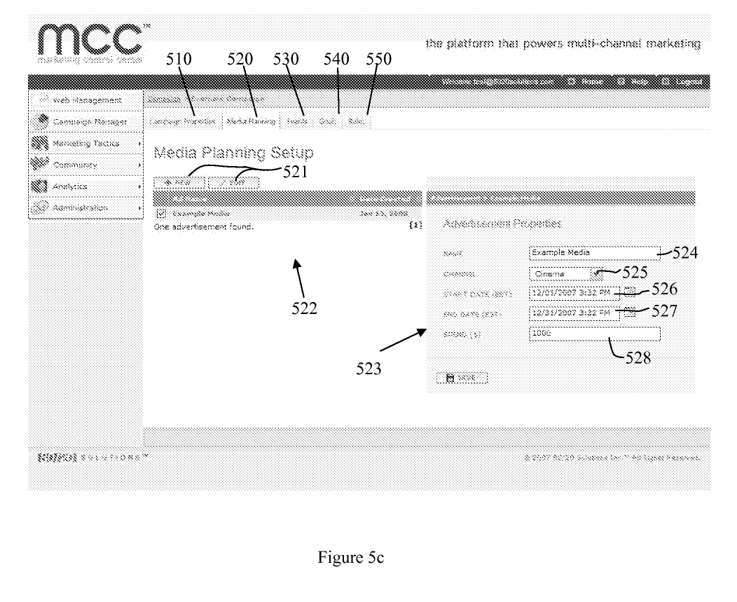

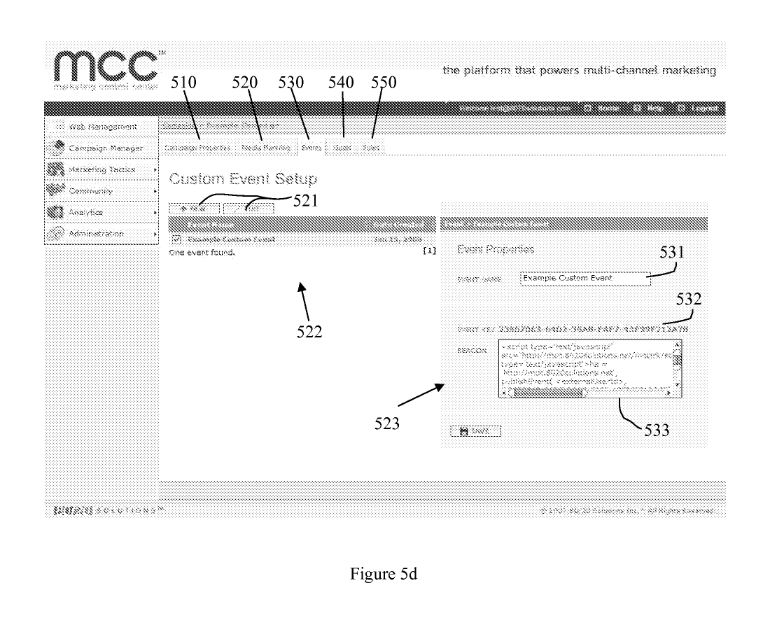

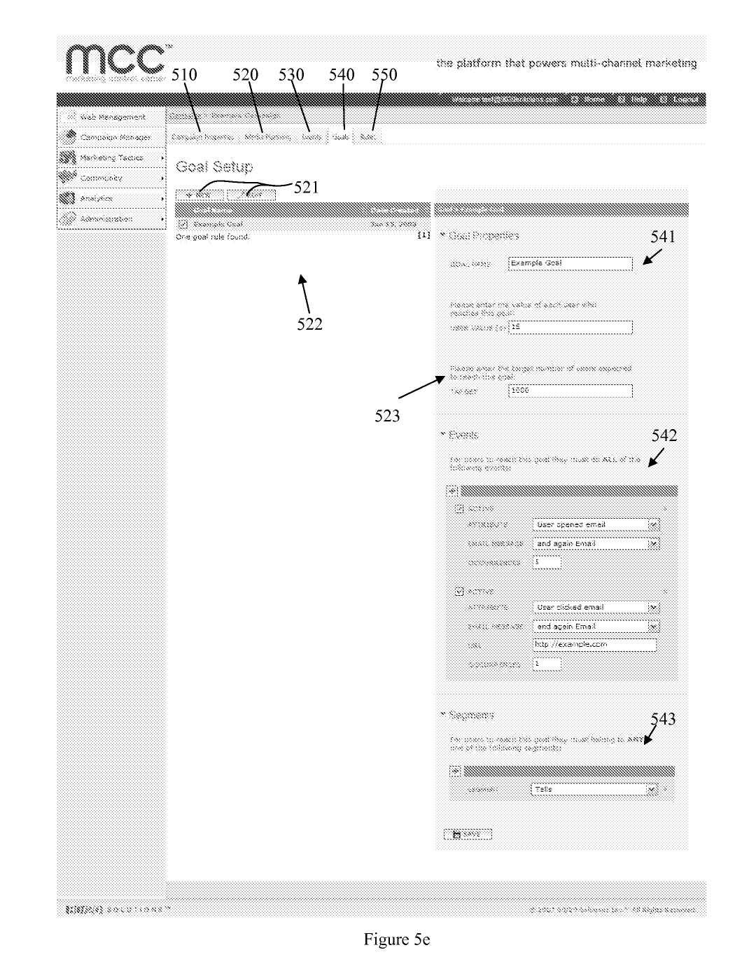

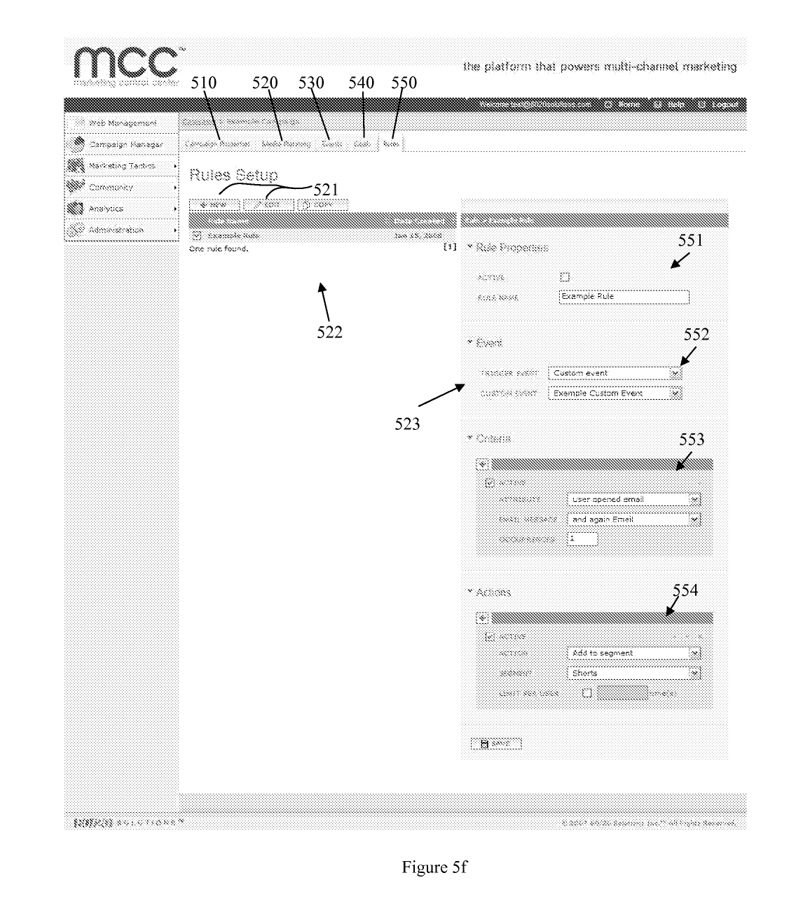

For ease of explanation only, the MCC 200 will now be described with reference to a sample marketing campaign as well as a sample user interface illustrated by sample screenshots in FIGS. 5 to 12. It will be appreciated that the order in which the screens are not intended to be limiting, but merely exemplary of a user experience.

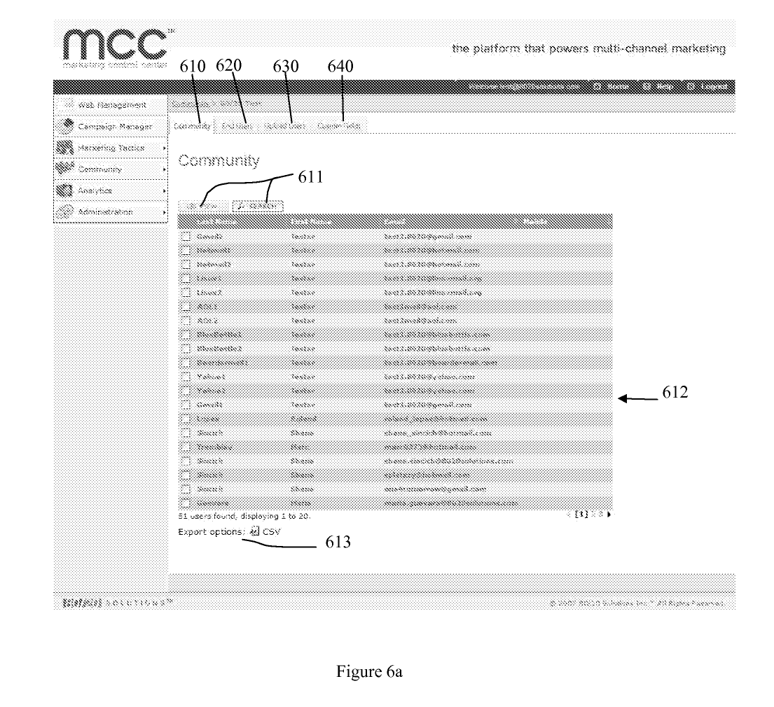

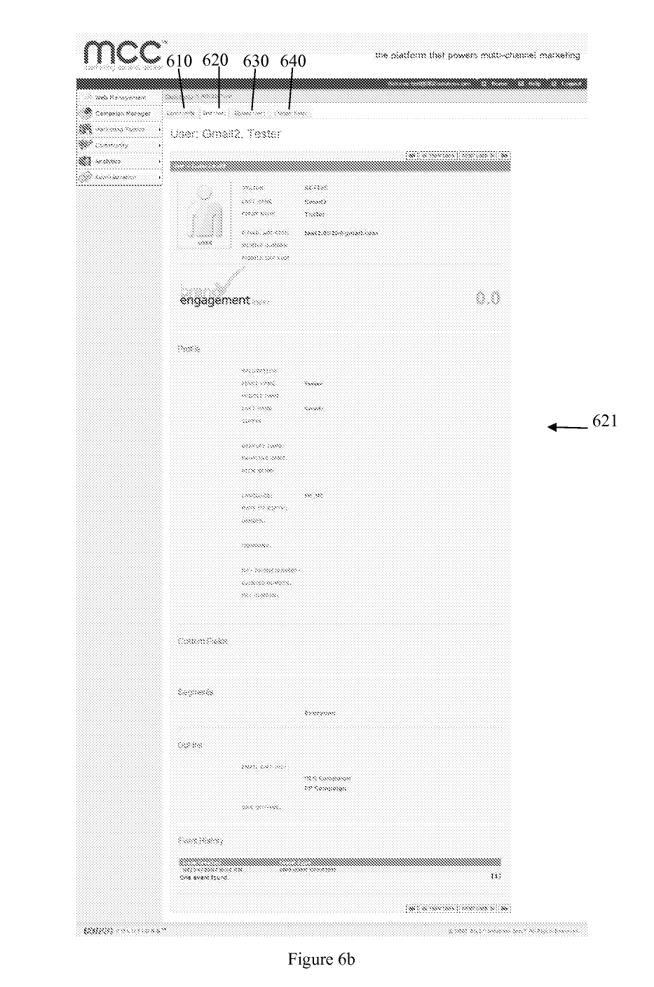

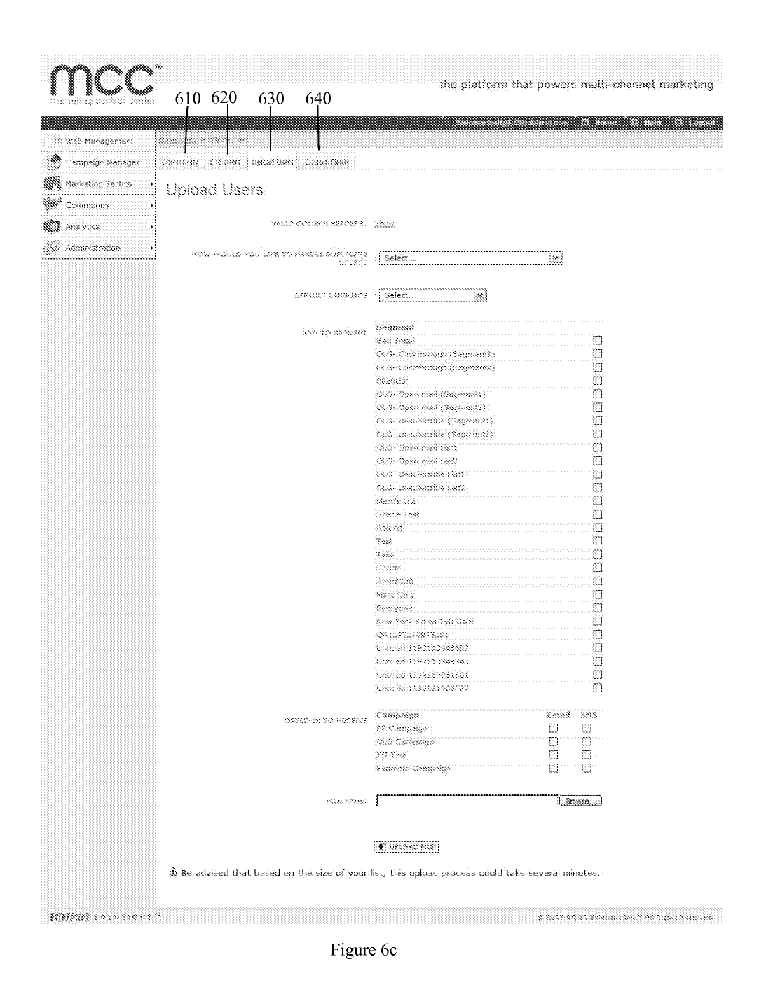

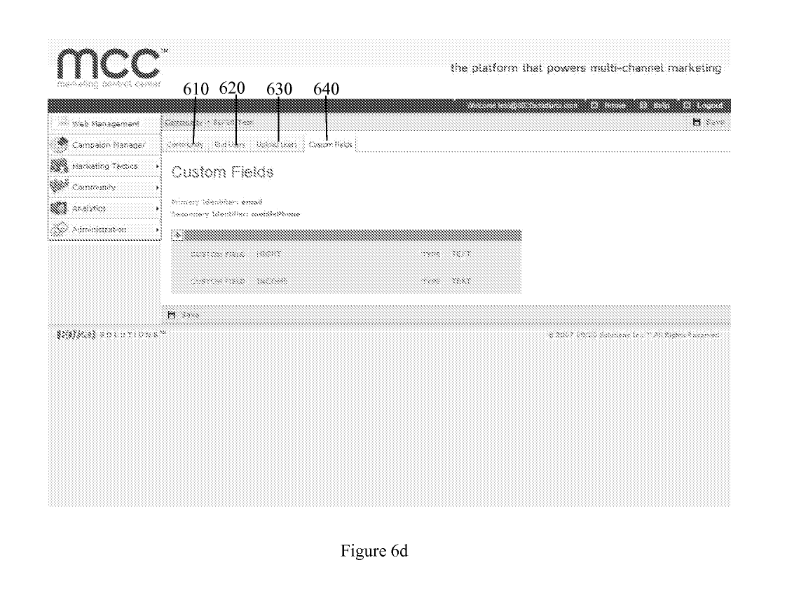

Referring to FIG. 6a, a main screen of the community section 410 is shown. The screen presents users with a tabbed document interface to the community module 202b for managing community details. As is known in the art, a tabbed document interface is one that allows multiple documents to be contained within a single window, and uses tabs to navigate between the documents.

In the present embodiment, the interface to the community module 202b is a tabbed document interface including four tabs: community 610; end consumer 620; upload consumer 630; and custom fields 640.

The details of the community tab 610 are shown in FIG. 6a. The community tab 610 includes buttons 611 that allow a user to view details for one or more selected consumers or search for specific consumers. A list of consumers is also displayed in the main panel 612. It will be appreciated that a complete list may take several pages to view in its entirety. The community tab 610 also provides an option 613 to export the list of consumers via the data import module 202h.

The screen illustrated in FIG. 6b illustrates the end consumer tab 620. This tab 620 includes a pane 621 that illustrates all the details of the consumer. These details have either been manually entered by the user (or an administrator) or imported by the user (or an administrator) via the data import module 202h, as will be described with reference to FIG. 6c.

The screen illustrated in FIG. 6c illustrates the upload consumer tab 630. This tab 630 allows users and administrators to import consumers from an external source, such as a third party database. The user can define how to handle duplicate entries, select which segments to add the consumers, and subscribe the consumers to any campaigns that may already have been implemented. It will be appreciated that the imported consumers may also be dynamically assigned to a segment, depending on the filter defined for the segment and the information available. For example, if a segment exists for consumers in Chicago and the uploaded information includes location information, any uploaded consumers in Chicago will automatically become part of the Chicago segment.

The screen illustrated in FIG. 6d illustrates the custom fields tab 640. The custom fields tab allows the user to create custom fields for the community. In the present embodiment, standard fields such as e-mail address, mobile phone number, land-based telephone number, and address are example of standard fields of information for each consumer. However, if it is desired, the user can create custom fields. In the present example, the custom fields include height and income.

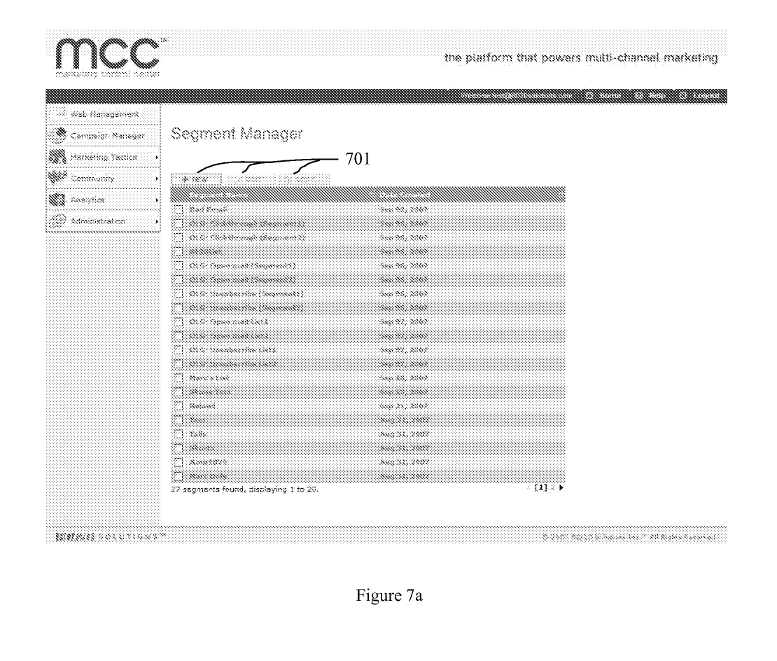

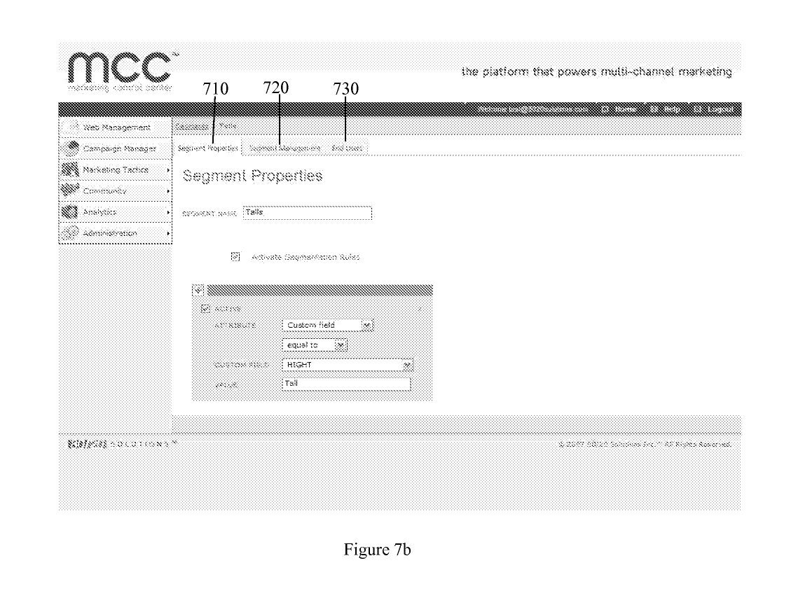

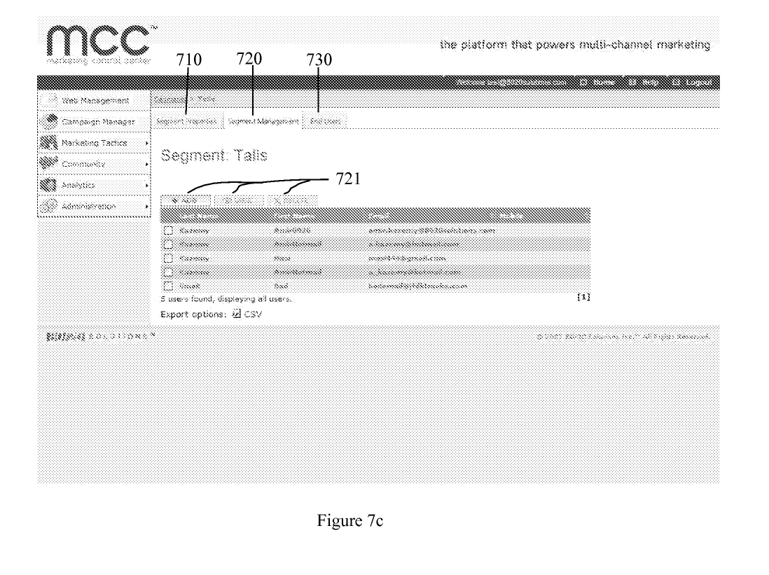

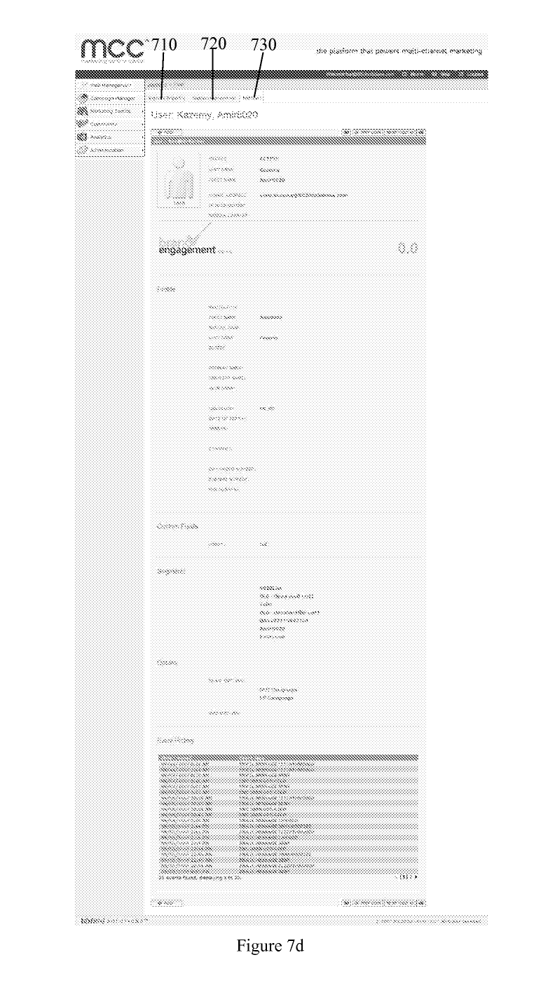

Referring to FIG. 7a, a segment manager is shown. The segment manager allows the user to create and manage segments of consumers. The segment manager presents the user with a list of the segments and includes buttons 701 that allow the user to create new segments, edit selected ones of the segments and copy existing segments.

Once a segment has been selected or the user decides to create a new segment, the user is presented with the segment tabbed document interface illustrated in FIGS. 7b through 7c. The segment tabbed document interface includes a segment properties tab 710, a segment management tab 720, and an end consumer tab 730.

Referring to FIG. 7b, the screen for the segment properties tab 710 is shown. The properties tab 710 includes the segment name as well as rules for the segment. In the present example, the segment is named ‘Talls’ and comprises all consumers where the custom field ‘height’ is equal to tall. Although the present example includes only one condition for defining the segment, it will be appreciated that multiple conditions can be used.

Referring to FIG. 7c, the screen for the segment management tab 720 is shown. The segment management tab 720 provides a list of consumers who are members of a selected segment. The user is provided with buttons 721 that can be used to add consumers to the segment, view consumers within a segment, and delete consumers from a segment.

Referring to FIG. 7d, the screen for the end consumer tab 730 is shown. Details of a selected consumer, including brand engagement information, are shown on the screen.

Referring to FIGS. 5a to 5f the interface to the campaign module 202c is illustrated. FIG. 5a is the main screen for the campaign section 406. As illustrated, a list 502 of campaigns is presented to the user. The user can edit an existing campaign by selecting the desired campaign from the list 502 clicking on an edit campaign button 504. Alternatively, the user can add a new campaign by clicking on an add campaign button 506.

Once a campaign has been selected or the user decides to create a new campaign, the user is presented with the campaign tabbed document interface illustrated in FIGS. 5b through 5f. In the present embodiment, the interface to the campaign module 202c includes five tabs: campaign properties 510; media planning 520; events 530; goals 540; and rules 550.

The screen illustrated in FIG. 5b illustrates the campaign properties tab 510. The screen includes a text box 511 for entering a campaign name, a drop down list 512 for selecting a corresponding website, a text box 513 for entering a campaign start date, a text box 514 for entering a campaign end date (if one exists), and a text box 515 for entering a description of the campaign. The drop down list 512 includes a list of websites available to the user as well as an option to create a new website. If the user chooses to create a new website at this point, the user is automatically presented with a user interface to the CMS module 202d.

The screen illustrated in FIG. 5c illustrates the media planning tab 520. Buttons 521 are provided to allow the user to either create a new media plan or edit an existing one. A list of existing media plans is shown in a panel 522 on the left side of the screen. A panel 523 on the right side of the screen illustrates the properties of the media plan. The properties include the name 524, media channel 525, start date 526 of the media plan, end date 527 of the media plan and the amount of money 528 spent on the media plan.

The screen illustrated in FIG. 5d illustrates the events tab 530. Buttons 521 are provided to allow the user to either create a new event or edit an existing one. A list of existing events is shown in a panel 522 on the left side of the screen. A panel 523 on the right side of the screen illustrates the properties of the event. In the present example a custom event is shown and the custom event includes an event name 531, an event key 532, and a beacon 533.

In the present example, the beacon 533 is a java beacon and comprises javascript generated by the campaign module 202c. The user can select the javascript and embed it in any web page, either internal or external to the MCC. Each time the web page is accessed, the beacon notifies the campaign module using the event key. Accordingly, it will be appreciated that the beacon provides easy to monitor events on web pages external to the campaign. However, it will be appreciated that a beacon could also be embedded into a campaign web site.

Although not shown, events can also be defined based on predefined criteria, such as a specific number of consumers performing a common task or a consumer performing a number of different tasks.

The screen illustrated in FIG. 5e illustrates the goals tab 540. Buttons 521 are provided to allow the user to either create a new goal or edit an existing one. A list of existing goals is shown in a panel 522 on the left side of the screen. A panel 523 on the right side of the screen illustrates the properties of the goal 541, as well as associated events 542 and segments 543.

In the goal properties 541, the user enters a goal name, a value per consumer and a target number of consumers expected to reach the goal. The associated events 542 define events that have to occur in order for the goal to be achieved. The segments 543 define one or more segments to which the consumer must belong in order to be counted toward reaching the goal. In the example illustrated in FIG. 5e, when a consumer belonging to the segment “Talls” opens an e-mail and clicks on a link in the email, the consumer will be counted as reaching the goal.

The screen illustrated in FIG. 5f illustrates the rules tab 550. Buttons 521 are provided to allow the user to either create a new rule and edit or copy an existing one. A list of existing rules is shown in a panel 522 on the left side of the screen. A panel 523 on the right side of the screen illustrates the properties of 551 the rules, as well as associated events 552, criteria 553 and actions 554.

The rule properties 551 include information relating to the rule such as a rule name and whether or not the rule is active. The associated events determine events that can trigger the rule. The rule criteria 553 determine activities that have to have occurred before rule can be implemented. Rule actions define what actions occur once the trigger event has been generated and the criteria have been met. Accordingly, it will be appreciated that the rule allows the user to target users across cross-platform integration between different media, marketing platforms and/or campaigns. For example, a rule could be implemented to target consumers with an “advanced” campaign only once the consumer has interacted sufficiently with a “basic” campaign. Similarly, a rule could be implemented to target consumers with an e-mail marketing campaign if they have participated successfully in an SMS marketing campaign.

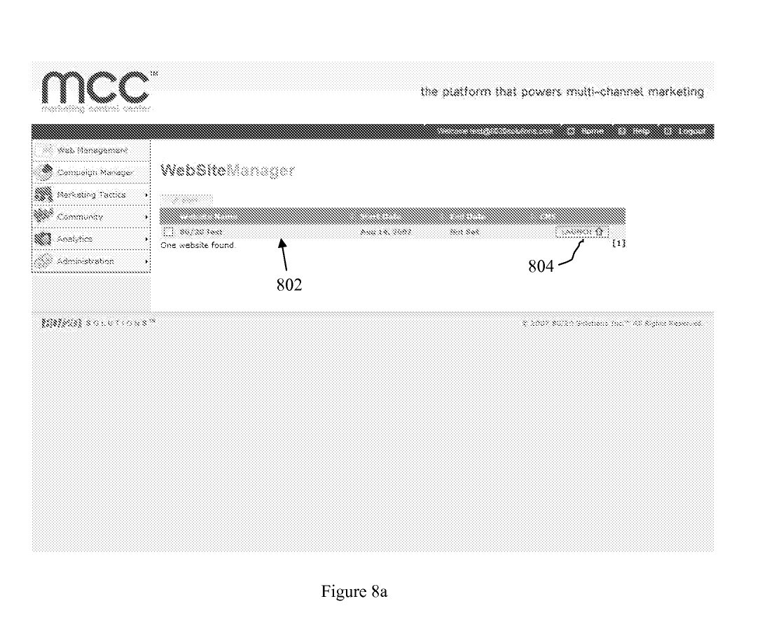

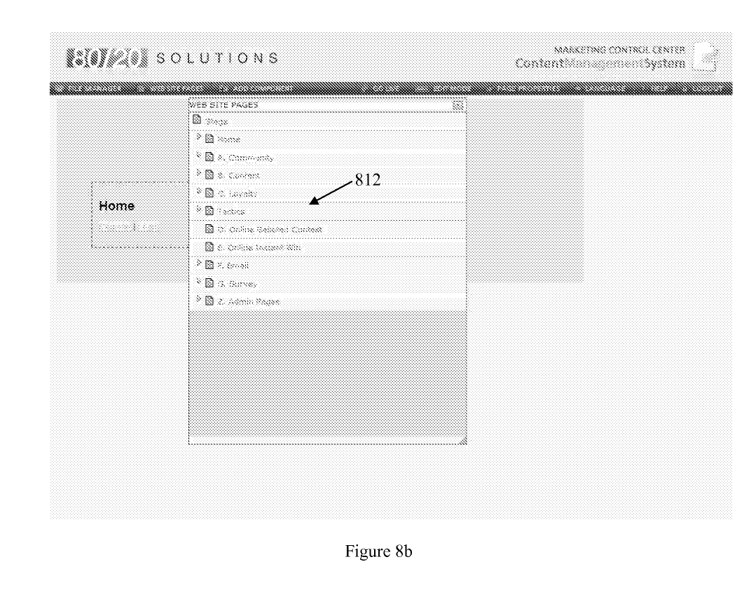

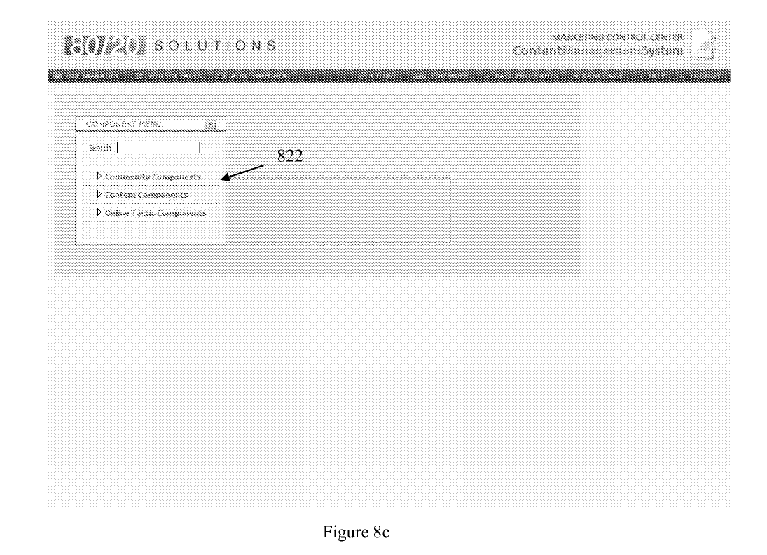

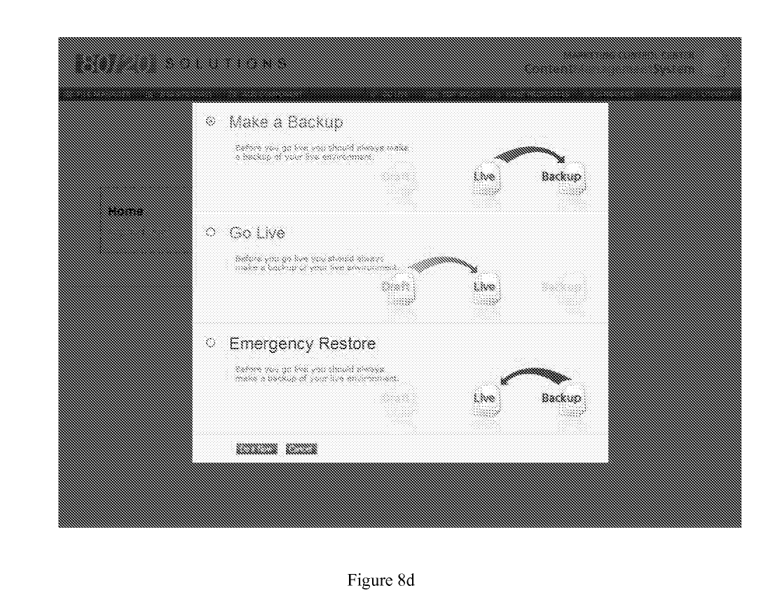

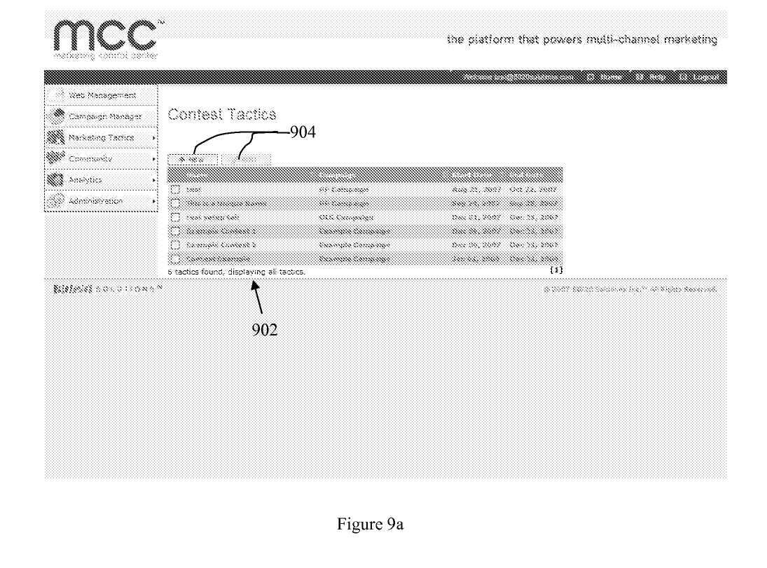

Referring to FIG. 8a, an interface to the CMS module 202d is shown. The interface includes a list 802 of available websites. Each website has a corresponding launch button 804 which launches the CMS 202d module. The CMS module 202d is a state of the art CMS that has been customized for the MCC 200, as will be appreciated by a person of ordinary skill in the art. Referring to FIGS. 8b and 8c illustrate a couple of sample screens illustrating such a customization. For example, in FIG. 8b a list of web pages 812 is shown. As another example, in FIG. 8c a list of components that can be dragged and dropped into the website is shown.

Each marketing tactic appears automatically in the CMS as a separate component. The CMS menu provides a drag and drop interface for the user to use in assembling the web page. Each of the marketing tactics can be dragged and dropped into any desired area on the web site.

Additionally, the CMS offers a pre-built suite of web 2.0 applications, such as web logs (blogs), polls, wiki, message boards and the like. Each of these can be easily configured and deployed entirely by users.

The CMS is also scalable, allowing users to manage web sites of all sizes from small campaign micro sites to large web portals. Furthermore, the CMS is collaborative, and allows permission-based input by dispersed contributors at various permission levels. For example, a web designer can create an overall theme and layout of web pages for a web site. The web designer can log-in to the MCC 200 and provide the web pages for a selected marketing campaign. Content contributors can then log-in to the MCC and add content such as text, images, audio, video by uploading their content into a content editor and placing the content on the web pages. The content editor provides a simple graphical user interface (GUI) for the content contributors to place the content on the web pages, such as drag and drop, for example.

Once content has been added, it is saved by the content contributor. The next step depends on the authority of the content contributor. For example, if the content contributor is the user then the web site can be promoted so that it is made available via the network, as shown in FIG. 8d, at the designated network address/domain name.

In another example, if the web site needs to be approved before being promoted, the content contributor submits the changes into a queue for approval by a supervisor. In the present embodiment, a supervisor is a person, or persons, with the authority to approve and promote the web site. For a collaborative project, the supervisor may wait until all the content contributors have submitted their submission to the queue or may review each content contributor's submission as they are queued. Once the supervisor has approved the content, the web site can be promoted so that the web site is accessible with the network by selecting a “go live” option, such as a button of menu option on the web portal GIU.

Further, if a content contributor or supervisor wishes to make changes to a web page, the changes can be made in a similar fashion to that described above. Once the change are approved and promoted they will be reflected at the web site.

The CMS also tracks detailed information on the usage of the web site, which is available in real-time in the analytics section 412, and helps to optimize web traffic and flow.

It should be noted that even though the CMS is optimized for non-technical user, it also contains many additional features for more sophisticated technical users including raw HTML editing, velocity tagging, and the ability to support custom-coded java portlets, for example.

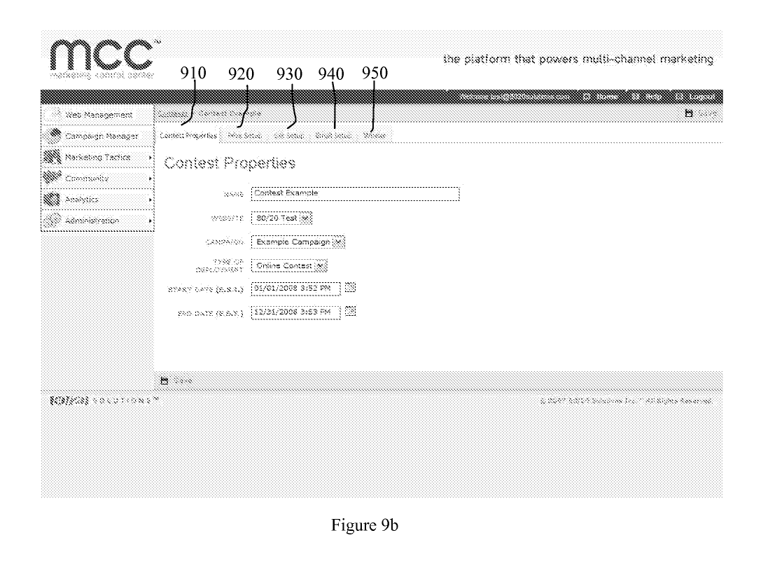

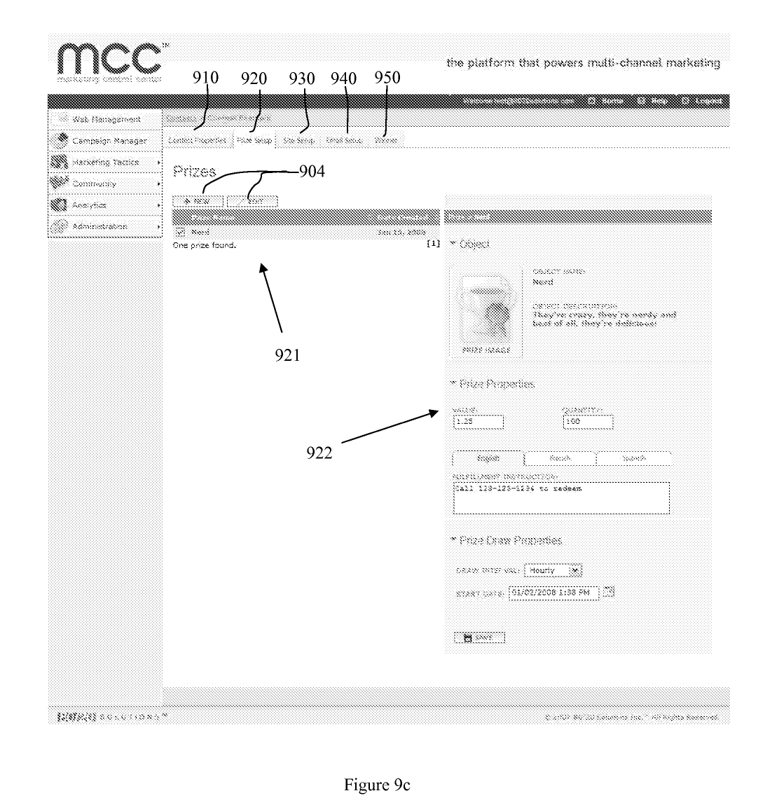

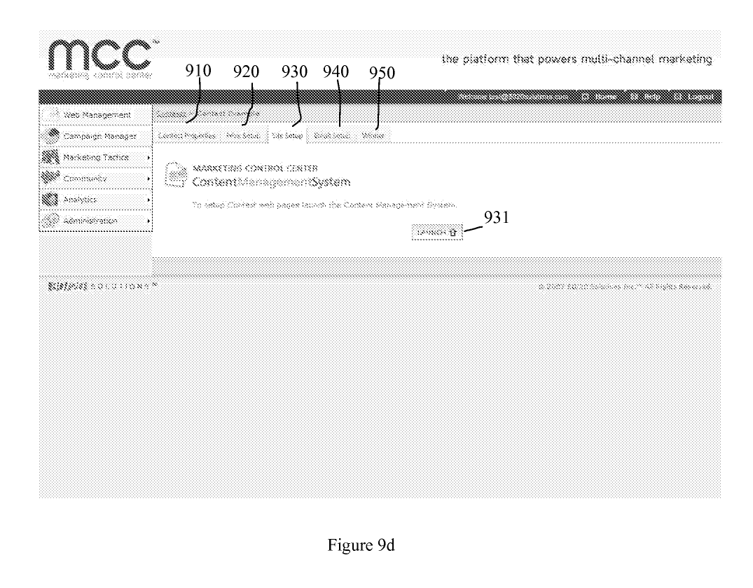

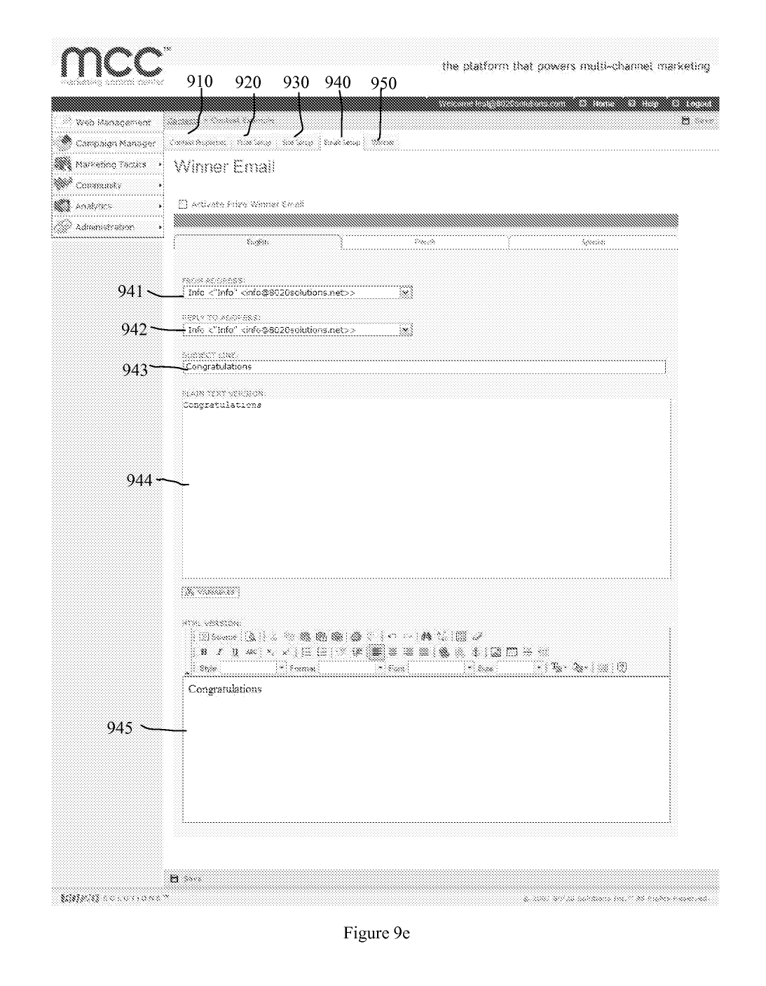

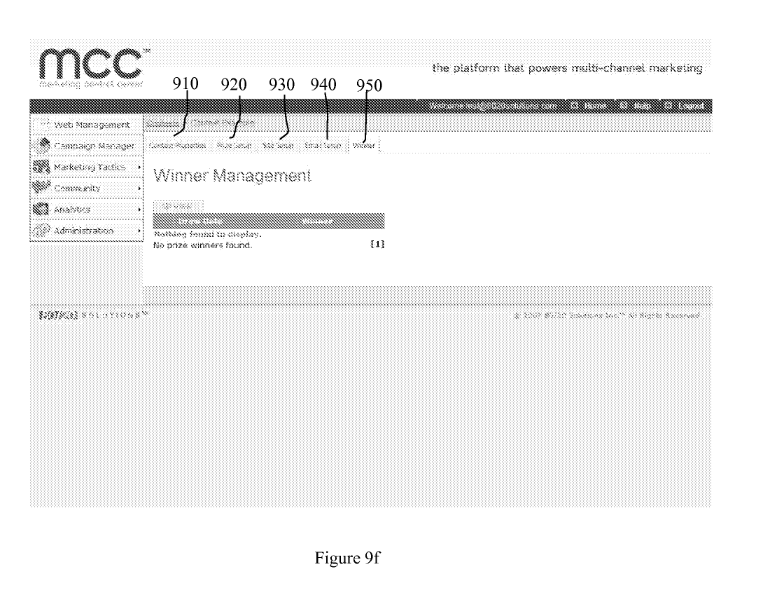

Referring to FIG. 9a, a contest tactics screen is shown. The contest tactics screen allows the user to create and manage contests for the consumers. The contest tactics screen presents the user with a list of the contests and includes buttons 904 that allow the user to create new contests and edit selected ones of the contests.

Once a contest has been selected or the user decides to create a new contest, the user is presented with the segment tabbed document interface illustrated in FIGS. 9b through 9f. The segment tabbed document interface includes a contest properties tab 910, a prize setup tab 920, a site setup tab 930, an e-mail setup tab 940 and a winger tab 950.

Referring to FIG. 9b, the screen for the contest properties tab 910 is shown. The properties tab 910 includes the contest name, a corresponding contest website, a corresponding campaign, the type of deployment, as well as the start and end dates of the contest. The type of deployment relates the type of contest, such an online contest, e-mail contest, SMS contest and the like.

Referring to FIG. 9c, the screen for the prize setup tab 920 is shown. The prize setup tab 920 includes buttons for adding a new prize or editing existing prizes, a panel 921 listing the existing prizes and a panel detailing each prize as it is selected in the list. The details of the prize include, for example, the value of the prize, the quantity of the prizes available, fulfillment instructions and prize draw properties.

Referring to FIG. 9d, the screen for the site setup tab 930 is shown. The site setup tab 930 includes a button 931 that launches the CMS module 202d to edit the site for the contest.

Referring to FIG. 9e, the screen for the winner setup tab 940 is shown. The winner setup tab 940 establishes an email template for notifying a consumer that they have won the contest. The template includes a from address 941, a reply-to address 942, a subject line 943, a plain text version 944 of a message, and a HTML version 945 of the message.

Referring to FIG. 9f, the screen for the winner tab 950 is shown. The winner tab 950 provides the user with a list of prize winners for the contest.

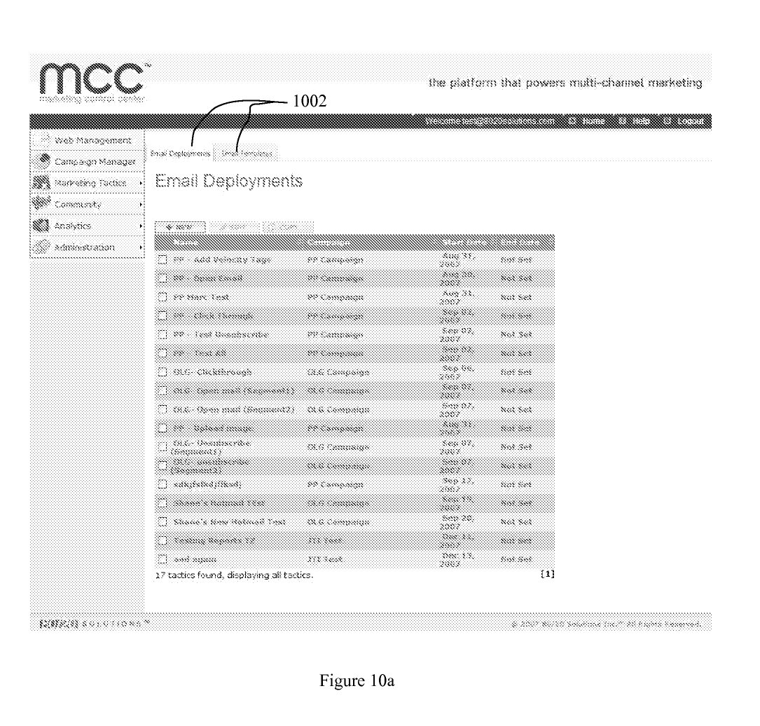

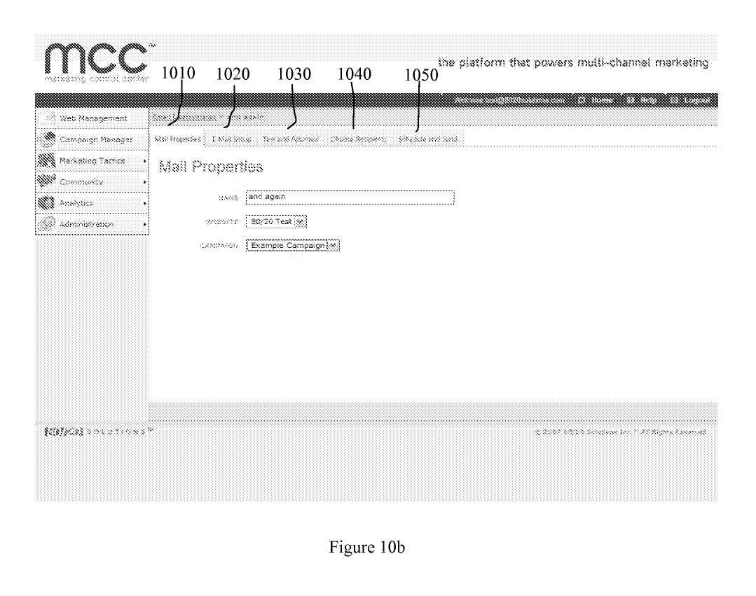

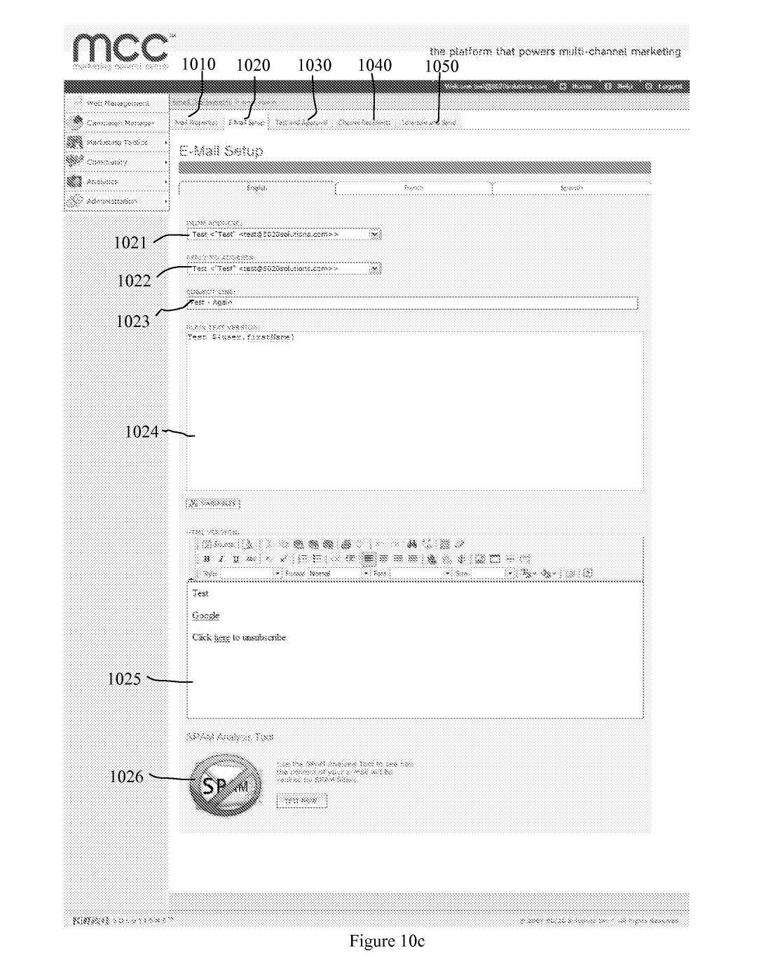

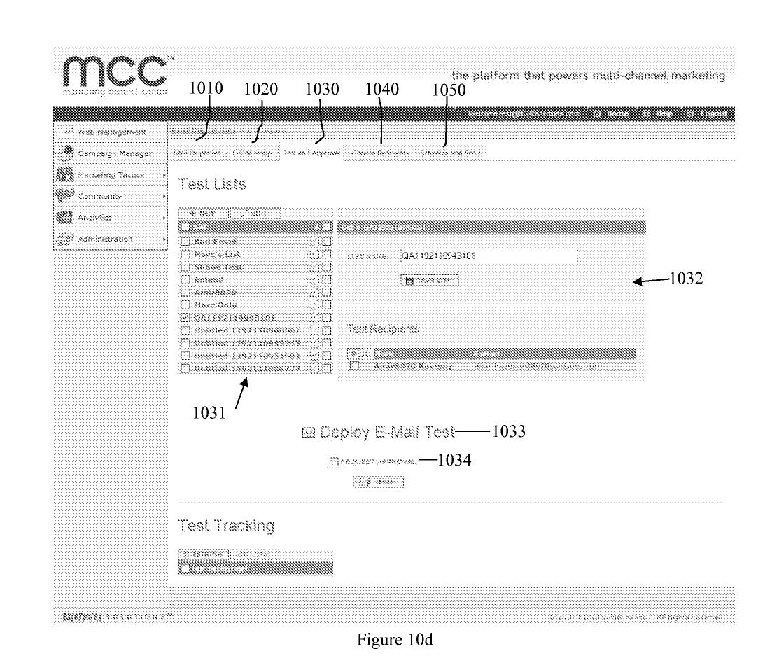

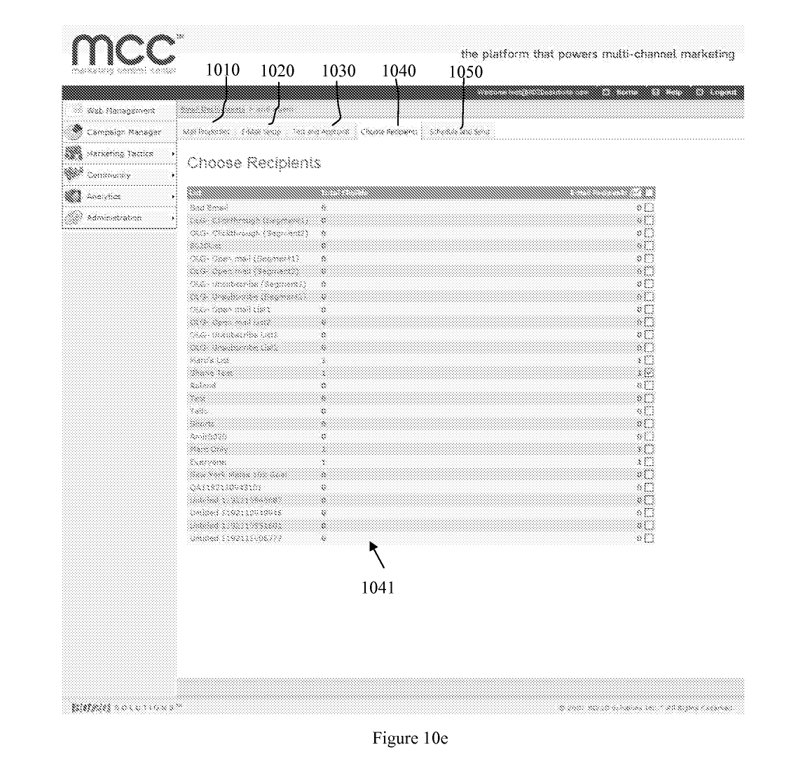

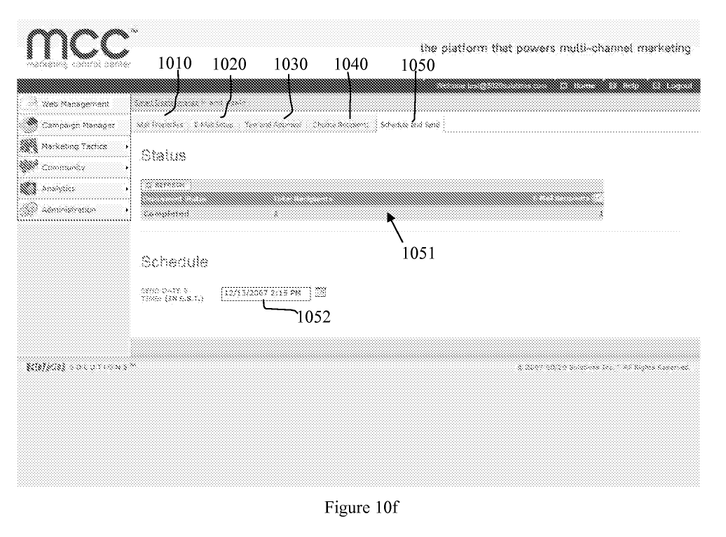

Referring to FIG. 10a, an email deployment screen is shown. The email deployment screen allows the user to create and deploy email message to the consumers for a given campaign. The email deployment screen presents the user with a list of the campaign and includes buttons 1002 that allow the user to create new email deployments and establish email templates.

Once a campaign has been selected, the user is presented with the segment tabbed document interface illustrated in FIGS. 10b through 10f. The segment tabbed document interface includes a mail properties tab 1010, an email setup tab 1020, a test tab 1030, a choose recipients tab 1040 and a schedule tab 1050.

Referring to FIG. 10b, the screen for the mail properties tab 1010 is shown. The properties tab 1010 includes the name of the mail deployment, the name of the campaign, and the associated website.

Referring to FIG. 10c, the screen for the email setup tap 1020 is shown. The email setup tab 1020 establishes an email template for transmitting a message to a consumer. The template includes a from address 1021, a reply-to address 1022, a subject line 1023, a plain text version 1024 of a message, a HTML version 1025 of the message, and a spam analysis tool. The spam analysis tool checks the email to determine the likelihood that the message will be blocked by typical mailbox filters.

Referring to FIG. 10d, the screen for the test tab 1030 is shown. The test tab 1030 includes a list 1031 of available email templates, a name 1032 of the list, a test button 1033 and an approval check box 1034. If the approval check box is selected when the test button 1033 is selected, an administrator or supervisor will be notified and asked for approval before the email can be deployed to the consumers.

Referring to FIG. 10e, the screen for the choose recipients tab 1040 is shown. The choose recipients tab 1040 presents the user with a list 1041 of segments to whom to send the email. It will be appreciated that if a consumer is listed on multiple segments, it is possible to restrict the number of emails sent so that duplicates are not sent. Further, it will be appreciated that individual consumers can be added in addition to the segments.

Referring to FIG. 10f, the screen for the schedule tab 1050 is shown. The schedule tab 1050 provides the user with an input field 1052 to establish a transmission date and time to begin the email deployment. Further a list 1051 of the email deployments and their corresponding deployment status is displayed.

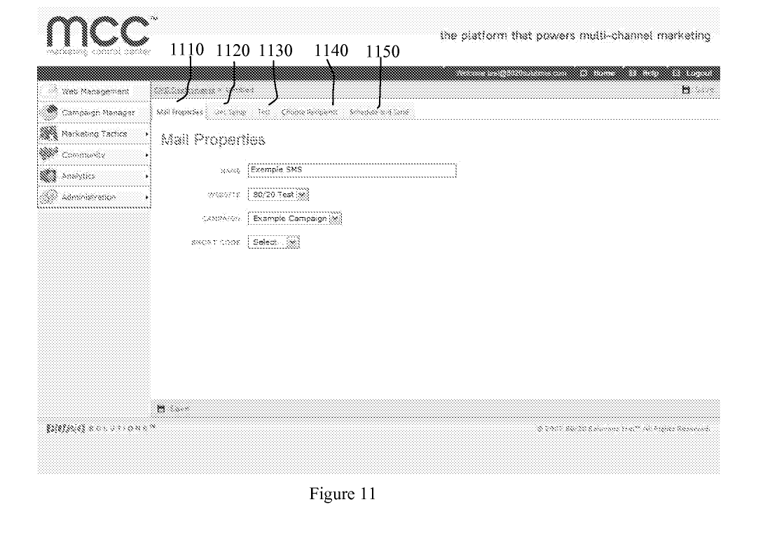

Referring to FIG. 11, a SMS deployment screen is shown. The SMS deployment is very similar to the email deployment screen described with reference to FIGS. 10a to 10f. Accordingly, for convenience, only SMS properties tab 1110 is shown. Once a campaign has been selected for an SMS campaign, the user is presented with the segment tabbed document interface illustrated in FIG. 11. The segment tabbed document interface includes a SMS properties tab 1110, an SMS setup tab 1120, a SMS test tab 1130, a SMS choose recipients tab 1140 and a SMS schedule tab 1150. The SMS properties, which is shown in FIG. 11, includes a name for the SMS deployment, a corresponding website, an associated campaign, and a corresponding short code.

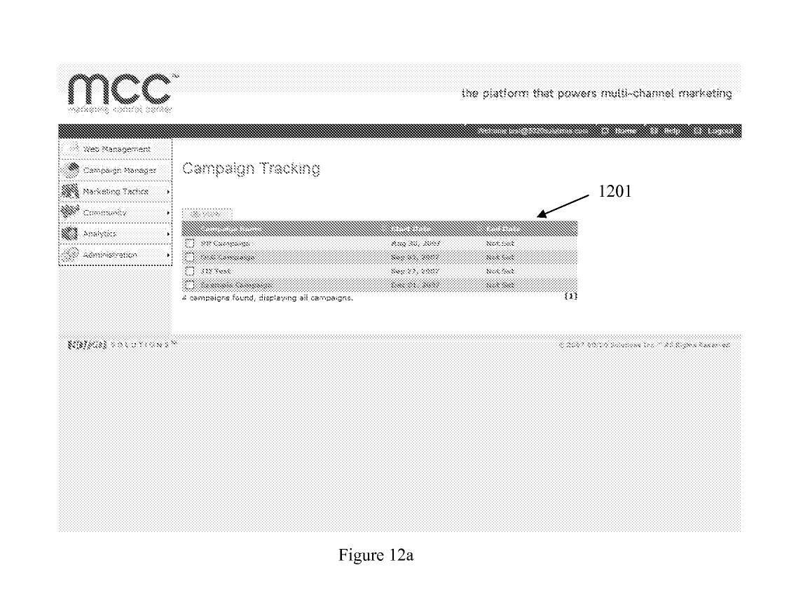

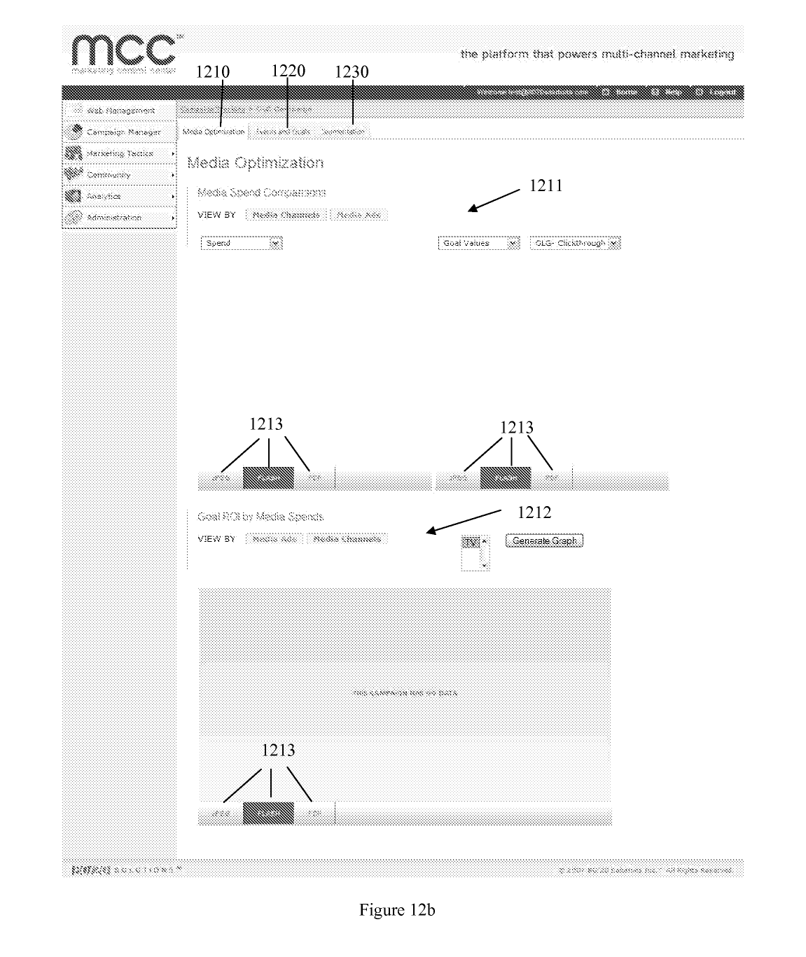

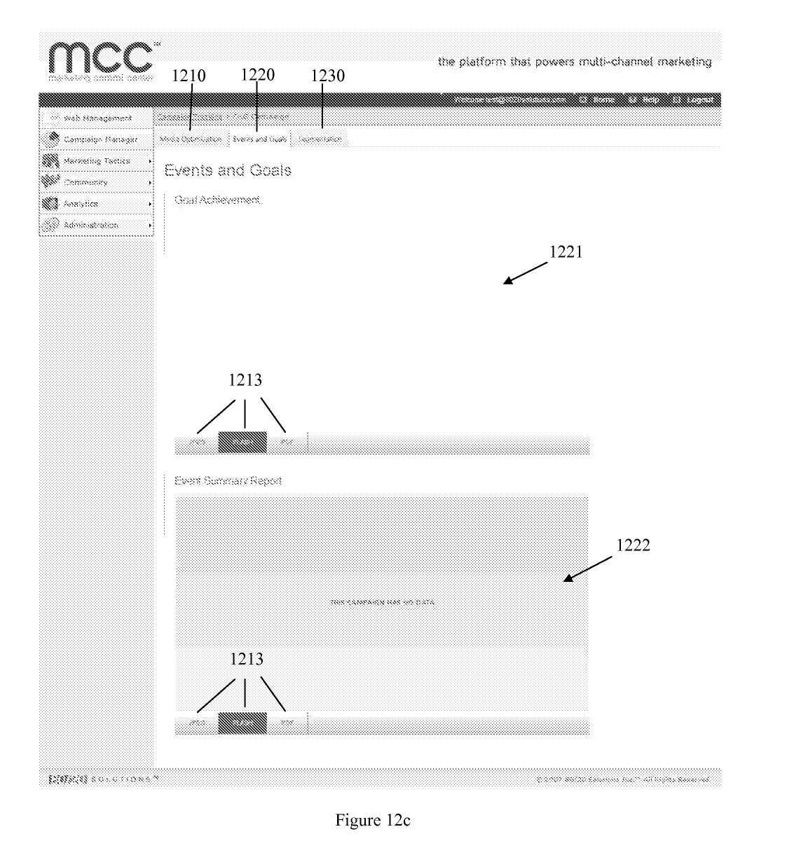

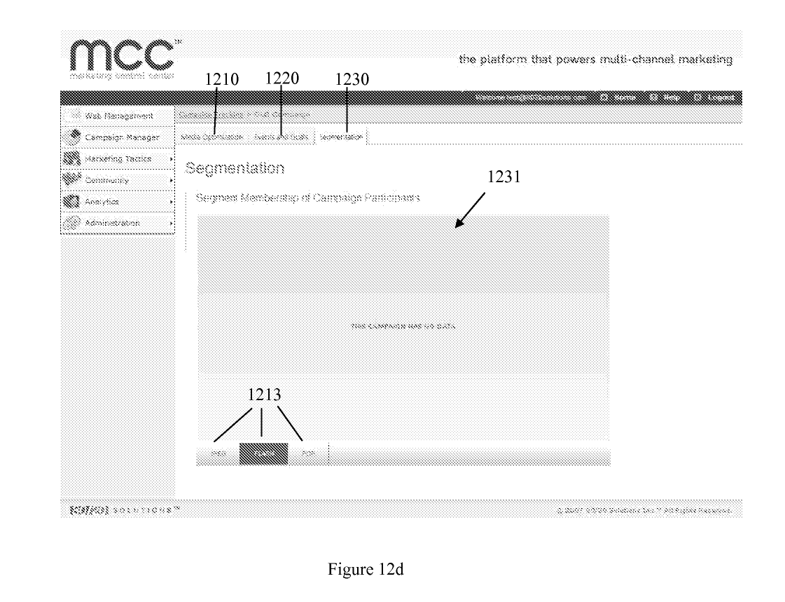

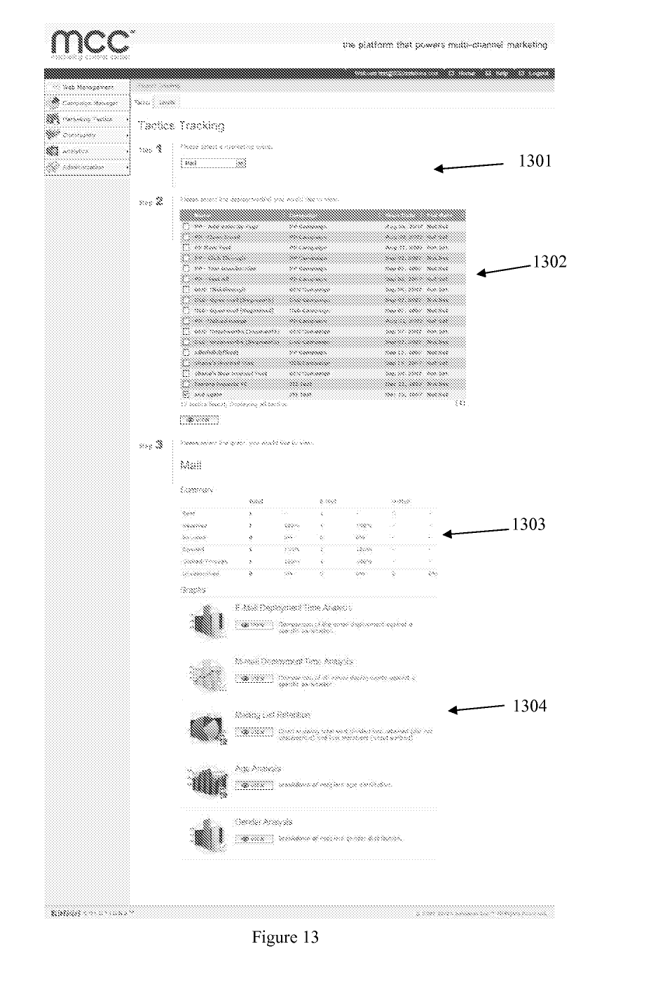

Referring to FIG. 12a, a campaign tracking screen is shown. The campaign tracking screen presents the user with a visual display of the status of the campaign in real-time. Therefore, the user can view the progress of the campaign at any time and determine how to proceed. For example, the user can determine that a particular tactic, such as a newspaper add is generating a better return on investment than another tactic, such as an email deployment, and shift any remaining resources accordingly. The campaign tracking screen provides the user with a list 1201 of campaigns from which to select.

Once a campaign has been selected, the user is presented with the segment tabbed document interface illustrated in FIGS. 12b through 10d. The segment tabbed document interface includes a media operation tab 1210, an events and goals tab 1220, and a segmentation tab 1130.

Referring to FIG. 12b, the screen for the media operation tab 1210 is shown. The media operation tab 1210 includes two sections: a media spend comparison section 1211 and a goal ROI section. The media spend comparison section graphs the amount of money spent on each media tactic in the campaign. The graph is illustrated using flash, but the user can select either JPEG or PDF format by selecting a format button 1213. Upon selection of the format button, a snapshot of the graph is taken and the graph can be exported in the selected format. The goal ROI section graphs the ROI based on the amount spent. This information can be used to get a picture of how the tactics are working within a campaign.

Referring to FIG. 12c, the screen for the events and goal tab 1220 is shown. The events and goals tab 1220 includes a goals achievement section 1221 and an event summary section 1222. The goals achievement section graphs the goals is comparison to actual achievement for the campaign. The event summary section 1222 provides a graphical representation of the events achieved to date in the campaign.

Referring to FIG. 12d, the screen for the segmentation tab 1230 is shown. The segmentation tab 1230 includes a segmentation section 1231 that graphs the segment membership so that the user can quickly determine which segments are more active in the campaign.

Referring to FIG. 13, as example of a more detail tactic analysis is shown. In the tactic analysis shown, the user is presented with a tactic selection section 1301 for selecting a marketing tactic. In the present example, the selected tactic is mail. The user is also presented with a deployment list 1302 that lists the deployments for the tactic selected in section 1301. The deployment list 1302 allows the user to select the deployments to review. A summary section 1303 summarizes the information relating to the selected deployments and a graph section 1304 present the user with different possible options for graphing the results.

Accordingly, it will be appreciated that the MCC provides the user with real-time information regarding multiple platform so that the user can dynamically modify the campaign to improve the overall return on investment. Furthermore, the MCC provides the user with the ability to market across a plurality of different platforms based on a predefined, customizable rule set.

Although the invention has been described with reference to certain specific embodiments, various modifications thereof will be apparent to those skilled in the art without departing from the scope of the invention as defined by the appended claims. For example, although the present embodiment specifically discloses and ASP model for the MCC, a person of ordinary skill in the art will appreciate that the MCC could be packaged and sold individually as a standalone software product, using more traditional software methods.

What is claimed is:

1. A method for providing efficient marketing campaigns across a plurality of platforms to a community of a plurality of consumers, the community comprising a plurality of segments defined by applying predefined filters to the community; the method comprising the steps of:
deploying marketing campaigns that target one or more segment of the community;
detecting triggers based on events, the events based on predefined event criteria; and
implementing cross-platform integration by deploying further marketing campaigns in accordance a predefined rule set, the rule set configured to deploy the further marketing campaigns in accordance with the detected trigger and predefined rules criteria.

2. The method of claim 1, further comprising the step of defining marketing goals and using the establishment of the goals as part of the predefined rules criteria.

3. A method of claim 1, further comprising providing the step of analyzing data from the marketing campaigns in real-time and presenting results of the analysis.

4. The method of claim 3, further comprising the step of dynamically modifying the deployed marketing campaigns in accordance with the analyzed data to improve performance thereof.

5. A computer system configured to implement efficient marketing campaigns across a plurality of platforms to a plurality of consumers, the computer comprising memory for storing:
a community manager configured to allow a user to manage and dynamically segment the plurality consumers;
a campaign manager configured to allow the user to establish a plurality of marketing campaigns for targeting at least a predefined segment of the plurality of consumers, each of the marketing campaigns including a plurality of different tactics;
a content management system configured to allow the user to create, host and manage content in real-time for the marketing campaign; and
a rules engine configured to implement one or both of different tactics or different campaigns in accordance a predefined set of rules, each rule defining a trigger event and corresponding rule criteria;
the computer further including a processor configured to execute the community manager, the campaign manager and the content manager, as well as to implement the rules when the trigger event is detected and the rules criteria are met, thereby facilitating cross-platform integration.

6. The computer system of claim 5, wherein the memory further comprises a reporting module configured to analyse data related to the tactics of the marketing campaigns in real time, and the processor is configured to execute the reporting module and present the results to the user.

7. The computer system of claim 5, wherein the tactics include one or more of contests, surveys, loyalty programs or instant win promotions.

8. The computer system of claim 5, wherein the campaigns include one or more of e-mail campaigns, short message service (SMS) campaigns, social networking campaigns, auctions, e-commerce campaigns, multimedia message service (MMS) campaigns, direct mail campaigns, call centre campaigns, interactive voice response (IVR) campaigns; gaming campaigns or television campaigns.

9. The computer system of claim 5 further comprising an integration application program interface (API) for facilitating access to third party tactic modules configured to provide the user to access additional tactics.

10. The computer system of claim 5 further comprising an integration application program interface (API) for facilitating access to third party campaign modules configured to provide the user with access to additional campaigns.

11. The computer systems of claim 5 further comprising a client interface API configure to facilitate the development of different client interfaces to the computer system.

12. The computer system of claim 6, wherein the memory further comprises a brand engagement module configured to record activities performed by the consumers weighted in accordance priorities defined by the user.

13. The computer system of claim 12, therein the priority is customer referrals.

14. A client computer configured to access a server via a network, the server implementing efficient marketing campaigns across a plurality of platforms to a plurality of consumers the server comprising memory for storing:
a community manager configured to allow a user to manage and dynamically segment the plurality consumers;
a campaign manager configured to allow the user to establish a plurality of marketing campaigns for targeting at least a predefined segment of the plurality of consumers, each of the marketing campaigns including a plurality of different tactics;
a content management system configured to allow the user to create, host and manage content in real-time for the marketing campaign; and
a rules engine configured to implement one or both of different tactics or different campaigns in accordance a predefined set of rules, each rule defining a trigger event and corresponding rule criteria;
the server further including a processor configured to execute the community manager, the campaign manager and the content manager, as well as to implement the rules when the trigger event is detected and the rules criteria are met, thereby facilitating cross-platform integration;
the client computer configured to allow the user to access the server in order to create and manage marketing campaigns and to view information executing by the server on a screen local to the client computer.
